(19) United States
(12) Patent Application Publication
(10) Pub. No.: US 2024/0310577 A1
(43) Pub. Date: Sep. 19, 2024

(54) OPTICAL DEVICE, OPTICAL TRANSMITTER, AND OPTICAL RECEIVER

(71) Applicant: FUJITSU OPTICAL COMPONENTS LIMITED, Kawasaki-shi (JP)

(72) Inventor: Masaki SUGIYAMA, Kawasaki (JP)

(73) Assignee: FUJITSU OPTICAL COMPONENTS LIMITED, Kawasaki-shi (JP)

(21) Appl. No.: 18/431,589

(22) Filed: Feb. 2, 2024

(30) Foreign Application Priority Data
Mar. 17, 2023 (JP) 2023-043534

(51) Int. Cl. G02B 6/122

(52) U.S. Cl. CPC G02B 6/1228

(57) ABSTRACT

An optical device includes a substrate, a first layer provided on the substrate on a side away from the substrate, a second layer provided on the substrate on a side closer to the substrate, and a third layer provided between the first layer and the second layer. The optical device includes a first waveguide arranged in the first layer, a second waveguide arranged in the second layer, a third waveguide arranged in the third layer, and a fourth waveguide arranged between the second layer and the substrate. The third waveguide is arranged at a position in which at least the first waveguide and a part of the second waveguide are overlapped in a surface direction of the substrate, and has a structure in which a width of the third waveguide is set to be narrower than a width of each of the first waveguide and the second waveguide.

### CROSS-REFERENCE TO RELATED APPLICATION

This application is based upon and claims the benefit of priority of the prior Japanese Patent Application No. 2023-043534, filed on Mar. 17, 2023, the entire contents of which are incorporated herein by reference.

### FIELD

The embodiments discussed herein are related to an optical device, an optical transmitter, and an optical receiver.

### BACKGROUND

In recent years, there are increased demands for optical fiber communication in accordance with an increase in communication capacity, so that small-sized optical devices that convert electrical signals to optical signals are used. Accordingly, in recent years, development of an ultra-compact substrate type optical waveguide element (hereinafter, simply referred to as an optical device) represented by silicon photonics is actively studied. As the optical device, an edge coupler in which two or more waveguides made of different materials can be integrally mounted on a same chip is used.

Each of the optical components constituting the optical device has a different characteristic depending on, for example, a material refractive index, so that it is possible to improve the characteristic of the optical device by using a waveguide that is made of a suitable material for each of the optical components. Therefore, the optical device constituted by using waveguides that are made of different materials has a structure in which light is adiabatically and optically transitioned between different waveguides.

FIG. 18 is a diagram illustrating one example of an optical device 100 that is conventionally used. The optical device 100 illustrated in FIG. 18 is a substrate type optical waveguide element that is optically coupled to a core of an optical fiber. The optical device 100 includes a clad 111 that is made of SiO₂, and a first waveguide 102 that is covered by the clad 111 and that is made of, for example, Si₃N₄ (hereinafter, simply referred to as Silicon Nitride (SiN)), or the like. The optical device 100 includes a second waveguide 104 that is covered by the clad 111 and that is made of, for example, Si or the like, and an adiabatic conversion section 105 in which light is adiabatically and optically transitioned between the first waveguide 102 and the second waveguide 104. Furthermore, the optical device 100 includes an inverse tapered section 106 that has a structure in which the waveguide width of the first waveguide 102 to the chip end surface D11 is gradually narrower.

The first waveguide 102 includes a first tapered waveguide 102A, and a second tapered waveguide 102B that is connected to the first tapered waveguide 102A. The first tapered waveguide 102A has a structure in which the waveguide width is gradually wider from an optical input-output section that is located in the vicinity of the chip end surface D11 toward a start point of the first tapered waveguide 102A. The second tapered waveguide 102B has a structure in which the waveguide width is gradually narrower as the second tapered waveguide 102B is away from the start point of the first tapered waveguide 102A when a portion that is connected to the start point of the first tapered waveguide 102A is regarded as a start point of the second tapered waveguide 102B.

The second waveguide 104 includes a third tapered waveguide 104A that is arranged at a position in which at least a part of the third tapered waveguide 104A is overlapped with the second tapered waveguide 102B away from the second tapered waveguide 102B, and includes a straight line waveguide 104B that is connected to the third tapered waveguide 104A. The third tapered waveguide 104A has a structure in which the waveguide width is gradually wider as the third tapered waveguide 104A is away from the start point of the second tapered waveguide 102B. The straight line waveguide 104B is a waveguide that is connected to a wider side of the waveguide width of the third tapered waveguide 104A.

FIG. 19A is a diagram illustrating one example of a schematic cross-sectional portion taken along line A-A illustrated in FIG. 18. The optical device 100 illustrated in FIG. 19A includes a Si substrate 112, and the clad 111 that is laminated on the Si substrate 112. The schematic cross-sectional portion illustrated in FIG. 19A taken along line A-A illustrated in FIG. 18 is a cross-sectional part of the optical device 100 in which the inverse tapered section 106 is arranged. Furthermore, the optical device 100 includes a first assembly layer 121A that is arranged on the side away from the Si substrate 112, and a second assembly layer 121B that is arranged on the side closer to the Si substrate 112. In the first assembly layer 121A, the first tapered waveguide 102A that is included in the first waveguide 102 is arranged.

FIG. 19B is a diagram illustrating one example of a schematic cross-sectional portion taken along line B-B illustrated in FIG. 18. The optical device 100 illustrated in FIG. 19B includes the Si substrate 112, the clad 111, the first assembly layer 121A, and the second assembly layer 121B. The schematic cross-sectional portion illustrated in FIG. 19B taken along line B-B illustrated in FIG. 18 is a cross-sectional part of the optical device 100 in which the adiabatic conversion section 105 is arranged. In the second assembly layer 121B, the third tapered waveguide 104A that is included in the second waveguide 104 is arranged. In the first assembly layer 121A, the second tapered waveguide 102B that is included in the first waveguide 102 is arranged.

FIG. 19C is a diagram illustrating one example of a schematic cross-sectional portion taken along line C-C illustrated in FIG. 18. The optical device 100 illustrated in FIG. 19C includes the Si substrate 112, the clad 111, the first assembly layer 121A, and the second assembly layer 121B. The schematic cross-sectional portion illustrated in FIG. 19C taken along line C-C illustrated in FIG. 18 is a cross-sectional part of the optical device 100 in which the straight line waveguide 104B is arranged. In the second assembly layer 121B, the straight line waveguide 104B that is included in the second waveguide 104 is arranged.

In the optical device 100 illustrated in FIG. 18, light is adiabatically transitioned from the second waveguide 104 to the first waveguide 102 that is arranged above the second waveguide 104 by way of the adiabatic conversion section 105, and is then coupled to an optical fiber by increasing a mode field of light at the inverse tapered section 106. In the adiabatic conversion section 105, the waveguide width of each of the first waveguide 102 and the second waveguide 104 is changed to a tapered shape. The refractive index of the first waveguide 102 is lower than that of the second waveguide 104, so that it is possible to increase the mode field of light, and it is thus possible to reduce a coupling loss with the optical fiber.
Patent Document 1: U.S. Patent Application Publication No. 2019/0154919
Patent Document 2: Japanese Laid-open Patent Publication No. 2014-191301
Patent Document 3: U.S. Patent Application Publication No. 2018/0224605

However, with the optical device 100 that is conventionally used, if the mode field is increased by using the first waveguide 102, the refractive index of the Si substrate 112 is larger than that of the SiN, so that an amount of light radiated from the first waveguide 102 to the Si substrate 112 is increased, and thus, the optical loss is increased.

### SUMMARY

According to an aspect of an embodiment, an optical device includes a substrate, a first assembly layer that is provided on the substrate on a side away from the substrate, a second assembly layer that is provided on the substrate on a side closer to the substrate, and a third assembly layer that is provided between the first assembly layer and the second assembly layer. The optical device further includes a first waveguide that is arranged in the first assembly layer, a second waveguide that is arranged in the second assembly layer, a third waveguide that is arranged in the third assembly layer, and a fourth waveguide that is arranged between the second assembly layer and the substrate. The third waveguide is arranged at a position in which at least the first waveguide and a part of the second waveguide are overlapped in a surface direction of the substrate, and has a structure in which a waveguide width of the third waveguide is set to be narrower than a waveguide width of each of the first waveguide and the second waveguide.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating one example of an optical device according to a first embodiment;

FIG. 2A is a diagram illustrating one example of a schematic cross-sectional portion taken along line A-A illustrated in FIG. 1;

FIG. 2B is a diagram illustrating one example of a schematic cross-sectional portion taken along line B-B illustrated in FIG. 1;

FIG. 2C is a diagram illustrating one example of a schematic cross-sectional portion taken along line C-C illustrated in FIG. 1;

FIG. 2D is a diagram illustrating one example of a schematic cross-sectional portion taken along line D-D illustrated in FIG. 1;

FIG. 3 is a diagram illustrating one example of an optical device according to a second embodiment;

FIG. 4A is a diagram illustrating one example of a schematic cross-sectional portion taken along line A-A illustrated in FIG. 3;

FIG. 4B is a diagram illustrating one example of a schematic cross-sectional portion taken along line B-B illustrated in FIG. 3;

FIG. 4C is a diagram illustrating one example of a schematic cross-sectional portion taken along line C-C illustrated in FIG. 3;

FIG. 4D is a diagram illustrating one example of a schematic cross-sectional portion taken along line D-D illustrated in FIG. 3;

FIG. 5 is a diagram illustrating one example of an optical device according to a third embodiment;

FIG. 6 is a diagram illustrating one example of a schematic cross-sectional portion taken along line A-A illustrated in FIG. 5;

FIG. 7 is a diagram illustrating one example of an optical device according to a fourth embodiment;

FIG. 8A is a diagram illustrating one example of a schematic cross-sectional portion taken along line A-A illustrated in FIG. 7;

FIG. 8B is a diagram illustrating one example of a schematic cross-sectional portion taken along line B-B illustrated in FIG. 7;

FIG. 9 is a diagram illustrating one example of an optical device according to a fifth embodiment;

FIG. 10A is a diagram illustrating one example of a schematic cross-sectional portion taken along line A-A illustrated in FIG. 9;

FIG. 10B is a diagram illustrating one example of a schematic cross-sectional portion taken along line B-B illustrated in FIG. 9;

FIG. 11 is a diagram illustrating one example of an optical device according to a sixth embodiment;

FIG. 12A is a diagram illustrating one example of a schematic cross-sectional portion taken along line A-A illustrated in FIG. 11;

FIG. 12B is a diagram illustrating one example of a schematic cross-sectional portion taken along line B-B illustrated in FIG. 11;

FIG. 13 is a diagram illustrating one example of an optical device according to a seventh embodiment;

FIG. 14A is a diagram illustrating one example of a schematic cross-sectional portion taken along line A-A illustrated in FIG. 13;

FIG. 14B is a diagram illustrating one example of a schematic cross-sectional portion taken along line B-B illustrated in FIG. 13;

FIG. 15 is a diagram illustrating one example of an optical communication apparatus that includes, as a built-in unit, an optical device;

FIG. 16 is a diagram illustrating one example of an optical device according to a comparative example;

FIG. 17A is a diagram illustrating one example of a schematic cross-sectional portion taken along line A-A illustrated in FIG. 16;

FIG. 17B is a diagram illustrating one example of a schematic cross-sectional portion taken along line B-B illustrated in FIG. 16;

FIG. 17C is a diagram illustrating one example of a schematic cross-sectional portion taken along line C-C illustrated in FIG. 16;

FIG. 17D is a diagram illustrating one example of a schematic cross-sectional portion taken along line D-D illustrated in FIG. 16;

FIG. 18 is a diagram illustrating one example of an optical device that is conventionally used;

FIG. 19A is a diagram illustrating one example of a schematic cross-sectional portion taken along line A-A illustrated in FIG. 18;

FIG. 19B is a diagram illustrating one example of a schematic cross-sectional portion taken along line B-B illustrated in FIG. 18; and

FIG. 19C is a diagram illustrating one example of a schematic cross-sectional portion taken along line C-C illustrated in FIG. 18.

### DESCRIPTION OF EMBODIMENTS

In the following, an optical device capable of reducing an optical loss by suppressing an amount of light radiated to a substrate will be described.

### COMPARATIVE EXAMPLE

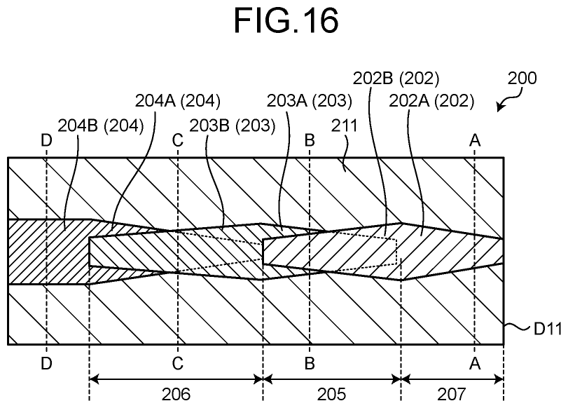

FIG. 16 is a diagram illustrating one example of an optical device 200 according to a comparative example. The optical device 200 illustrated in FIG. 16 is a substrate type optical waveguide element that is optically coupled to a core of an optical fiber. The optical device 200 illustrated in FIG. 16 includes a first waveguide 202, a second waveguide 203, a third waveguide 204, and a clad 211 that covers the first waveguide 202, the second waveguide 203 and the third waveguide 204. The first waveguide 202 and the second waveguide 203 is made of, for example, Si₃N₄ (hereinafter, simply referred to as SiN), and the material refractive index of SiN is 1.99 in the case where the optical wavelength is 1.55 μm. The third waveguide 204 is made of, for example, Si, and the material refractive index of Si is 3.48 in the case where the optical wavelength is 1.55 μm. The clad 211 is made of, for example, SiO₂, and the material refractive index of SiO₂ is 1.44 in the case where the optical wavelength is 1.55 μm.

The optical device 200 includes a first adiabatic conversion section 205 in which light is adiabatically transitioned between the first waveguide 202 and the second waveguide 203, and a second adiabatic conversion section 206 in which light is adiabatically transitioned between the second waveguide 203 and the third waveguide 204. Furthermore, the optical device 200 includes an inverse tapered section 207 that has a structure in which the waveguide width of the inverse tapered section 207 to the chip end surface D11 of the first waveguide 202 is gradually narrower.

The first waveguide 202 includes a first tapered waveguide 202A and a second tapered waveguide 202B. The first tapered waveguide 202A has a structure in which the waveguide width is gradually wider from the optical input-output section that is located in the vicinity of a chip end surface D11 and that is provided on a Si substrate 212 toward the start point. The second tapered waveguide 202B has a structure in which the waveguide width is gradually narrower as the second tapered waveguide 202B is away from the start point of the first tapered waveguide 202A when a portion that is connected to the start point of the first tapered waveguide 202A is regarded as a start point of the second tapered waveguide 202B.

The second waveguide 203 includes a third tapered waveguide 203A and a fourth tapered waveguide 203B. The third tapered waveguide 203A is arranged at a position in which at least a part of the third tapered waveguide 203A is overlapped with the second tapered waveguide 202B away from the second tapered waveguide 202B, and has a structure in which the waveguide width is gradually wider as the third tapered waveguide 203A is away from the start point of the second tapered waveguide 202B. The fourth tapered waveguide 203B has a structure in which the waveguide width is narrower as the fourth tapered waveguide 203B is away from the third tapered waveguide 203A when a portion that is connected to a wider side of the waveguide width of the third tapered waveguide 203A is regarded as a start point of the fourth tapered waveguide 203B.

The third waveguide 204 includes a fifth tapered waveguide 204A and a straight line waveguide 204B. The fifth tapered waveguide 204A is arranged at a position in which at least a part of the fifth tapered waveguide 204A is overlapped with the fourth tapered waveguide 203B away from the fourth tapered waveguide 203B, and has a structure in which the waveguide width is gradually wider as the fifth tapered waveguide 204A is away from the start point of the fourth tapered waveguide 203B. The straight line waveguide 204B is, for example, a waveguide that is connected to a wider side of the waveguide width of the fifth tapered waveguide 204A.

The optical device 200 has a structure in which a first assembly layer 221A that is provided on the side away from the Si substrate 212 and a second assembly layer 221B that is provided on the side closer to the Si substrate 212 are formed on the Si substrate 212.

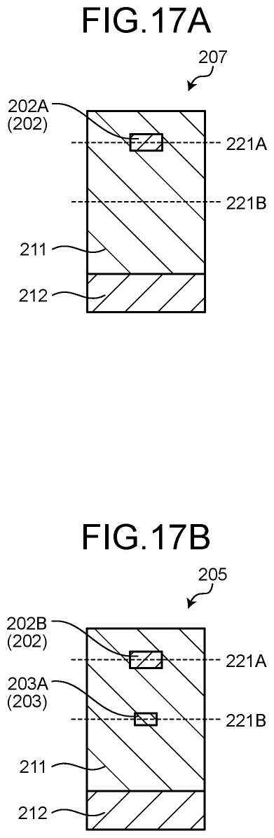

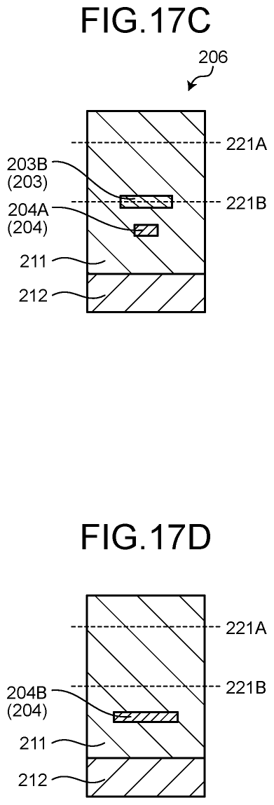

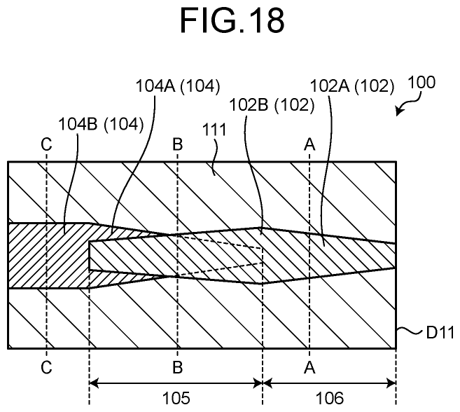

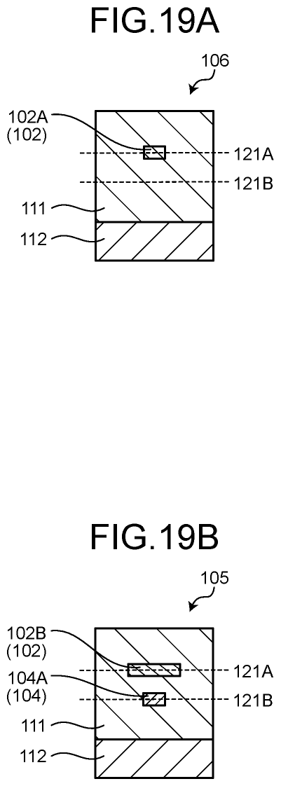

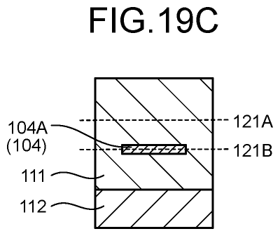

FIG. 17A is a diagram illustrating one example of a schematic cross-sectional portion taken along line A-A illustrated in FIG. 16. The schematic cross-sectional portion illustrated in FIG. 17A taken along line A-A illustrated in FIG. 16 is a cross-sectional part of the optical device 200 in which the inverse tapered section 207 is arranged. The optical device 200 includes the Si substrate 212, the clad 211 that is laminated on the Si substrate 212, the first assembly layer 221A, and the second assembly layer 221B.

In the first assembly layer 221A, the first tapered waveguide 202A that is included in the first waveguide 202 is arranged. The inverse tapered section 207 is coupled to the optical fiber that is located on the chip end surface D11 by increasing the mode field of light.

FIG. 17B is a diagram illustrating one example of a schematic cross-sectional portion taken along line B-B illustrated in FIG. 16. The schematic cross-sectional portion illustrated in FIG. 17B taken along line B-B illustrated in FIG. 16 is a cross-sectional part of the optical device 200 in which the first adiabatic conversion section 205 is arranged. The optical device 200 includes the Si substrate 212, the clad 211 that is laminated on the Si substrate 212, the first assembly layer 221A, and the second assembly layer 221B.

In the first assembly layer 221A, the second tapered waveguide 202B that is included in the first waveguide 202 is arranged. In the second assembly layer 221B, the third tapered waveguide 203A that is included in the second waveguide 203 is arranged. The first adiabatic conversion section 205 is arranged at a position in which the second tapered waveguide 202B and the fourth tapered waveguide 203B are overlapped in a separated manner, and, in the first adiabatic conversion section 205, light is adiabatically transitioned between the third tapered waveguide 203A and the second tapered waveguide 202B.

FIG. 17C is a diagram illustrating one example of a schematic cross-sectional portion taken along line C-C illustrated in FIG. 16. The schematic cross-sectional portion illustrated in FIG. 17C taken along line C-C illustrated in FIG. 16 is a cross-sectional part of the optical device 200 in which the second adiabatic conversion section 206 is arranged. The optical device 200 includes the Si substrate 212, the clad 211 that is laminated on the Si substrate 212, the first assembly layer 221A, and the second assembly layer 221B.

In the second assembly layer 221B, the fourth tapered waveguide 203B included in the second waveguide 203 is arranged. The fifth tapered waveguide 204A included in the third waveguide 204 is arranged between the second assembly layer 221B and the Si substrate 212. The second adiabatic conversion section 206 is arranged at a position in which the fourth tapered waveguide 203B and the fifth tapered waveguide 204A are overlapped in a separated manner, and, in the second adiabatic conversion section 206, light is adiabatically transitioned between the fourth tapered waveguide 203B and the fifth tapered waveguide 204A.

FIG. 17D is a diagram illustrating one example of a schematic cross-sectional portion taken along line D-D illustrated in FIG. 16. The schematic cross-sectional portion illustrated in FIG. 17D taken along line D-D illustrated in FIG. 16 is a cross-sectional part of the optical device 200 in which the straight line waveguide 204B included in the third waveguide 204 is arranged. The optical device 200 includes the Si substrate 212, the clad 211 that is laminated on the Si substrate 212, the first assembly layer 221A, and the second assembly layer 221B. The straight line waveguide 204B included in the third waveguide 204 is arranged between the second assembly layer 221B and the Si substrate 212.

The start point of the first adiabatic conversion section 205 is the start point of the second tapered waveguide 202B that is included in the first waveguide 202, and is also the end point of the third tapered waveguide 203A that is included in the second waveguide 203. The end point of the first adiabatic conversion section 205 is the end point of the second tapered waveguide 202B that is included in the first waveguide 202, and is also the start point of the third tapered waveguide 203A that is included in the second waveguide 203.

The start point of the second adiabatic conversion section 206 is the start point of the fourth tapered waveguide 203B that is included in the second waveguide 203, and is also the end point of the fifth tapered waveguide 204A that is included in the third waveguide 204. The end point of the second adiabatic conversion section 206 is the end point of the fourth tapered waveguide 203B that is included in the second waveguide 203, and is also the start point of the fifth tapered waveguide 204A that is included in the third waveguide 204.

In the optical device 200 according to the comparative example, the SiN waveguide is constituted to have two layers by using the first waveguide 202 and the second waveguide 203, and, in the first adiabatic conversion section 205, light is adiabatically transitioned from the second waveguide 203 to the first waveguide 202 that is arranged above the second waveguide 203. As a result, by arranging the first tapered waveguide 202A away from the Si substrate 212, it is possible to reduce the optical loss by suppressing an amount of light radiated from the first tapered waveguide 202A to the Si substrate 212.

However, in the optical device 200 according to the comparative example, in the case where the first waveguide 202 is disposed away from the second waveguide 203 in order to arrange the first waveguide 202 included in the first adiabatic conversion section 205 at a position away from the Si substrate 212, the efficiency of adiabatic conversion in the first adiabatic conversion section 205 is decreased. Accordingly, to increase the efficiency of the adiabatic conversion, it is conceivable to increase the length of the first adiabatic conversion section 205, but the size of the optical device may be increased.

Preferred embodiments of the present invention will be explained with reference to accompanying drawings. Furthermore, the present invention is not limited to the embodiments. In addition, the embodiments described below may also be used in any appropriate combination as long as the embodiments do not conflict with each other.

### (a) First Embodiment

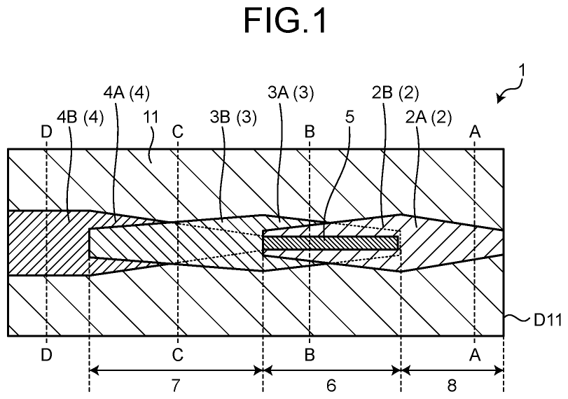

FIG. 1 is a diagram illustrating one example of the optical device 1 according to a first embodiment. The optical device 1 illustrated in FIG. 1 is a substrate type optical waveguide element that is optically coupled to a core of an optical fiber. The optical device 1 includes a first waveguide 2, a second waveguide 3, a third waveguide 5, a fourth waveguide 4, and a clad 11 that covers the first waveguide 2, the second waveguide 3, the third waveguide 5, and the fourth waveguide 4. Each of the first waveguide 2, the second waveguide 3, and the third waveguide 5 is made of, for example, Si₃N₄ (hereinafter, simply referred to as SiN), the material refractive index of SiN is 1.99 in the case where the optical wavelength is 1.55 μm. The fourth waveguide 4 is made of, for example, Si, and the material refractive index of Si is 3.48 in the case where the optical wavelength is 1.55 μm. The clad 11 is made of, for example, SiO₂, and the material refractive index of SiO₂ is 1.44 in the case where the optical wavelength is 1.55 μm.

The optical device 1 includes a first adiabatic conversion section 6 in which light is adiabatically transitioned between the first waveguide 2 and the second waveguide 3 by way of the third waveguide 5, and includes a second adiabatic conversion section 7 in which light is adiabatically transitioned between the second waveguide 3 and the fourth waveguide 4. The optical device 1 includes an inverse tapered section 8 that has a structure in which the waveguide width to the chip end surface D11 is gradually narrower.

The first waveguide 2 includes a first tapered waveguide 2A and a second tapered waveguide 2B. The first tapered waveguide 2A has a structure in which the waveguide width is gradually wider from an optical input-output section that is located in the vicinity of the chip end surface D11 and that is provided on a Si substrate 12 toward the start point of the first tapered waveguide 2A. In other words, the first tapered waveguide 2A has a structure in which the waveguide width is gradually narrower from the start point to the end point of the first tapered waveguide 2A. The second tapered waveguide 2B has a structure in which the waveguide width is gradually narrower as the second tapered waveguide 2B is away from the start point of the first tapered waveguide 2A when a portion that is connected to the start point of the first tapered waveguide 2A is regarded as the start point of the second tapered waveguide 2B.

The second waveguide 3 includes a third tapered waveguide 3A and a fourth tapered waveguide 3B. The third tapered waveguide 3A is arranged at a position in which at least a part of the third tapered waveguide 3A is overlapped with the second tapered waveguide 2B in a surface direction of the Si substrate 12 away from the second tapered waveguide 2B, and has a structure in which the waveguide width is gradually wider as the third tapered waveguide 3A is away from the start point of the second tapered waveguide 2B. The fourth tapered waveguide 3B has a structure in which the waveguide width is narrower as the fourth tapered waveguide 3B is away from the portion that is connected to the third tapered waveguide 3A when a portion that is connected to a wider side of the waveguide width of the third tapered waveguide 3A is regarded as the start point of the fourth tapered waveguide 3B.

The third waveguide 5 is arranged at a position in which at least the second tapered waveguide 2B and a part of the third tapered waveguide 3A are overlapped in a separated manner in a surface direction of the Si substrate 12, and has a structure in which the waveguide width is narrower than that of the first waveguide 2 and the second waveguide 3.

The fourth waveguide 4 includes a fifth tapered waveguide 4A and a straight line waveguide 4B. The fifth tapered waveguide 4A is arranged at a position in which the fourth tapered waveguide 3B and at least a part of the fifth tapered waveguide 4A are overlapped in a separated manner in the surface direction of the Si substrate 12, and has a structure in which the waveguide width is gradually wider as the fifth tapered waveguide 4A is away from the start point of the fourth tapered waveguide 3B. The straight line waveguide 4B is a waveguide that is connected to a wider side of the waveguide width of the fifth tapered waveguide 4A.

The optical device 1 includes a first assembly layer 21A, a second assembly layer 21B, and a third assembly layer 21C. The first assembly layer 21A is arranged on the Si substrate 12 on the side away from the Si substrate 12. The second assembly layer 21B is arranged on the Si substrate 12 on the side closer to the Si substrate 12. The third assembly layer 21C is arranged between the first assembly layer 21A and the second assembly layer 21B.

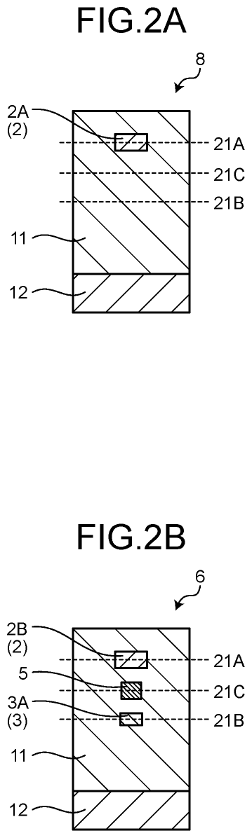

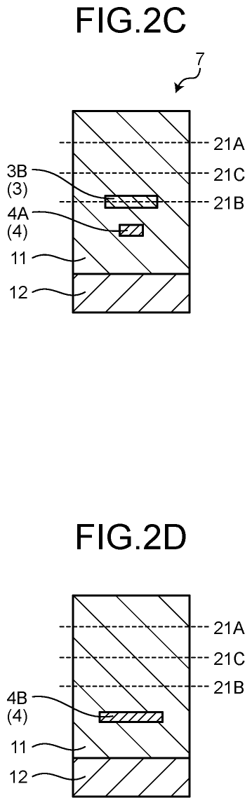

FIG. 2A is a diagram illustrating one example of a schematic cross-sectional portion taken along line A-A illustrated in FIG. 1. The schematic cross-sectional portion illustrated in FIG. 2A taken along line A-A illustrated in FIG. 1 is a cross-sectional part of the optical device 1 in which the inverse tapered section 8 is arranged. The optical device 1 includes the Si substrate 12, the clad 11 that is laminated on the Si substrate 12, the first assembly layer 21A, the second assembly layer 21B, and the third assembly layer 21C. In the first assembly layer 21A, the first tapered waveguide 2A that is included in the first waveguide 2 is arranged.

FIG. 2B is a diagram illustrating one example of a schematic cross-sectional portion taken along line B-B illustrated in FIG. 1. The schematic cross-sectional portion illustrated in FIG. 2B taken along line B-B illustrated in FIG. 1 is a cross-sectional part of the optical device 1 in which the first adiabatic conversion section 6 is arranged. The optical device 1 includes the Si substrate 12, the clad 11 that is laminated on the Si substrate 12, the first assembly layer 21A, the second assembly layer 21B, and the third assembly layer 21C. In the first assembly layer 21A, the second tapered waveguide 2B that is included in the first waveguide 2 is arranged. In the second assembly layer 21B, the third tapered waveguide 3A that is included in the second waveguide 3 is arranged. In the third assembly layer 21C, the third waveguide 5 is arranged. In the first adiabatic conversion section 6, light is adiabatically transitioned between the third tapered waveguide 3A and the second tapered waveguide 2B by way of the third waveguide 5 that is arranged at a position in which the second tapered waveguide 2B and the third tapered waveguide 3A are overlapped in a separated manner in the surface direction of the Si substrate 12.

FIG. 2C is a diagram illustrating one example of a schematic cross-sectional portion taken along line C-C illustrated in FIG. 1. The schematic cross-sectional portion illustrated in FIG. 2C taken along line C-C illustrated in FIG. 1 is a cross-sectional part of the optical device 1 in which the second adiabatic conversion section 7 is arranged. The optical device 1 includes the Si substrate 12, the clad 11 that is laminated on the Si substrate 12, the first assembly layer 21A, the second assembly layer 21B, and the third assembly layer 21C. In the second assembly layer 21B, the fourth tapered waveguide 3B that is included in the second waveguide 3 is arranged. The fifth tapered waveguide 4A that is included in the fourth waveguide 4 is arranged between the second assembly layer 21B and the Si substrate 1. In the second adiabatic conversion section 7, light is adiabatically transitioned between the fourth tapered waveguide 3B and the fifth tapered waveguide 4A, where the fourth tapered waveguide 3B and the fifth tapered waveguide 4A are overlapped in a separated manner in the surface direction of the Si substrate 12.

FIG. 2D is a diagram illustrating one example of a schematic cross-sectional portion taken along line D-D illustrated in FIG. 1. The schematic cross-sectional portion illustrated in FIG. 2D taken along line D-D illustrated in FIG. 1 is a cross-sectional part of the optical device 1 in which the straight line waveguide 4B that is included in the fourth waveguide 4 is arranged. The optical device 1 includes the Si substrate 12, the clad 11 that is laminated on the Si substrate 12, the first assembly layer 21A, the second assembly layer 21B, and the third assembly layer 21C. The straight line waveguide 4B that is included in the fourth waveguide 4 is arranged between the second assembly layer 21B and the Si substrate 12.

The start point of the first adiabatic conversion section 6 is the start point of the second tapered waveguide 2B that is included in the first waveguide 2, the end point of the third tapered waveguide 3A that is included in the second waveguide 3, and is also the start point of the third waveguide 5. The end point of the first adiabatic conversion section 6 is the end point of the second tapered waveguide 2B that is included in the first waveguide 2, the start point of the third tapered waveguide 3A that is included in the second waveguide 3, and is also the end point of the third waveguide 5.

The start point of the second adiabatic conversion section 7 is the start point of the fourth tapered waveguide 3B that is included in the second waveguide 3, and is also the start point of the fifth tapered waveguide 4A that is included in the fourth waveguide 4. The end point of the second adiabatic conversion section 7 is the end point of the fourth tapered waveguide 3B that is included in the second waveguide 3, and is also the start point of the fifth tapered waveguide 4A that is included in the fourth waveguide 4.

The optical device 1 according to the first embodiment is constituted to have a structure in which the third waveguide 5 is inserted between the first waveguide 2 and the second waveguide 3, and have a structure in which the waveguide width of the third waveguide 5 is set to be narrower than the waveguide width of each of the first waveguide 2 and the second waveguide 3. In other words, in the optical device 1, the waveguide width of the third waveguide 5 is set to be narrower than the waveguide width of each of the first waveguide 2 and the second waveguide 3. As a result, the mode field of light in the third waveguide 5 is increased, the mode field of light in the first waveguide 2 is largely overlapped with the mode field of light in the second waveguide 3, so that light is easily coupled between the waveguides. In other words, it is possible to significantly improve the coupling efficiency between the second waveguide 3 and the third waveguide 5 and improve the coupling efficiency between the third waveguide 5 and the first waveguide 2. Furthermore, it is possible to reduce the length of the waveguide needed for the adiabatic conversion. In other words, it is possible to improve the efficiency of the adiabatic conversion of the first adiabatic conversion section 6 without increasing the size of the first adiabatic conversion section 6. In addition, by suppressing an amount of light radiated from the first waveguide 2 to the Si substrate 12, it is possible to reduce the size of the optical device 1 while reducing the coupling loss with the optical fiber at the chip end surface D11.

In addition, in the first embodiment, the case has been described as an example in which the first waveguide 2 is constituted by the first tapered waveguide 2A and the second tapered waveguide 2B, the second waveguide 3 is constituted by the third tapered waveguide 3A and the fourth tapered waveguide 3B, and the fourth waveguide 4 is constituted by the fifth tapered waveguide 4A and the straight line waveguide 4B. However, the example is not limited to this. In other words, the third waveguide 5 may be arranged at a position in which at least the first waveguide 2 is overlapped with a part of the second waveguide 3 away from the second waveguide 3 in the surface direction of the Si substrate 12, and may have a structure in which the waveguide width of the third waveguide 5 is set to be narrower than the waveguide width of each of the first waveguide 2 and the second waveguide 3. As a result, the mode field of light in the third waveguide 5 is increased, the mode field of light in the first waveguide 2 is largely overlapped with the mode field of light in the second waveguide 3, so that light is easily coupled between the waveguides. In addition, it is possible to reduce the length of the waveguide needed for the adiabatic conversion while improving the coupling efficiency between the second waveguide 3 and the third waveguide 5 and improving the coupling efficiency between the third waveguide 5 and the first waveguide 2. In other words, it is possible to improve the efficiency of the adiabatic conversion in the first adiabatic conversion section 6 without increasing the size of the first adiabatic conversion section 6. In addition, by suppressing an amount of light radiated from the first waveguide 2 to the Si substrate 12, it is possible to reduce the size of the optical device 1 while reducing the coupling loss with the optical fiber at the chip end surface D11.

Furthermore, the straight line waveguide 4B that is included in the fourth waveguide 4 is not limited to the straight line, but may be, for example, a bent waveguide, and appropriate modifications are possible.

In addition, in the optical device 1 according to the first embodiment, the case has been described as an example in which a single piece of the third waveguide 5 is arranged between the first waveguide 2 and the second waveguide 3, but the example is not limited to this. It may be possible to arrange a plurality of waveguides, and an embodiment thereof will be described below as a second embodiment.

### (b) Second Embodiment

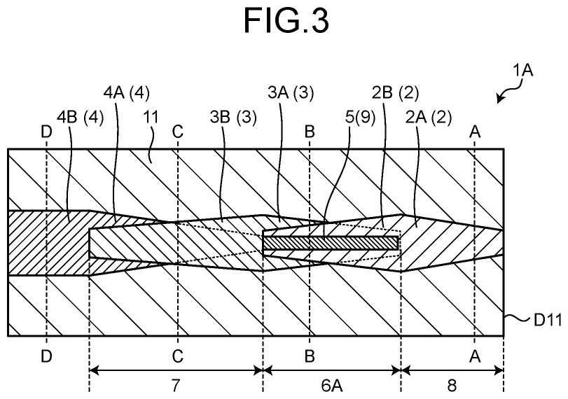

FIG. 3 is a diagram illustrating one example of an optical device 1A according to the second embodiment. In addition, by assigning the same reference numerals to components having the same configuration as those in the optical device 1 according to the first embodiment, overlapped descriptions of the configuration and the operation thereof will be omitted. The optical device 1 according to the first embodiment is different from the optical device 1A according to the second embodiment in that a single piece of a fifth waveguide 9 is arranged, in addition to arranging the single piece of the third waveguide 5 between the first assembly layer 21A and the second assembly layer 21B.

The third waveguide 5 is arranged in the third assembly layer 21C that is located between the first assembly layer 21A and the second assembly layer 21B. Furthermore, the fifth waveguide 9 that is a SiN waveguide is arranged in a fourth assembly layer 21D that is located between the third assembly layer 21C and the first assembly layer 21A.

The third waveguide 5 and the fifth waveguide 9 are arranged at a position in which at least the second tapered waveguide 2B and a part of the third tapered waveguide 3A are overlapped in a separated manner in the surface direction of the Si substrate 12, and has a structure in which the waveguide width is narrower than that of each of the first waveguide 2 and the second waveguide 3. In addition, the third waveguide 5 and the fifth waveguide 9 have substantially the same shape, even though the third waveguide 5 and the fifth waveguide 9 are arranged at different portions, i.e., the third assembly layer 21C and the fourth assembly layer 21D, respectively.

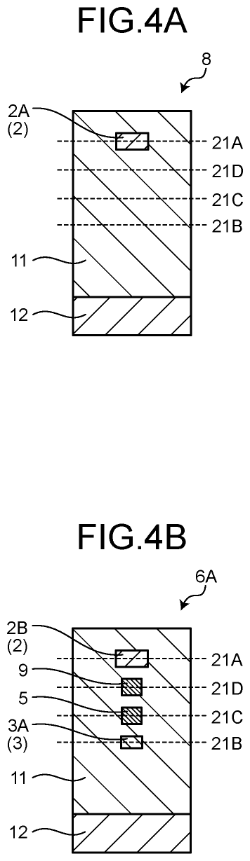

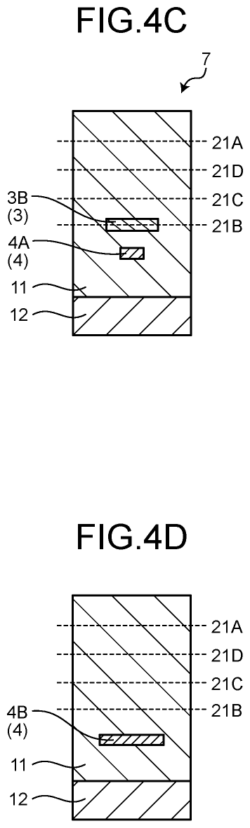

FIG. 4A is a diagram illustrating one example of a schematic cross-sectional portion taken along line A-A illustrated in FIG. 3. The schematic cross-sectional portion illustrated in FIG. 4A taken along line A-A illustrated in FIG. 3 is a cross-sectional part of the optical device 1A in which the inverse tapered section 8 is arranged. The optical device 1A includes the Si substrate 12, the clad 11 that is laminated on the Si substrate 12, the first assembly layer 21A, the second assembly layer 21B, the third assembly layer 21C, and the fourth assembly layer 21D. In the first assembly layer 21A, the first tapered waveguide 2A that is included in the first waveguide 2 is arranged. The inverse tapered section 8 is coupled to the optical fiber disposed at the chip end surface D11 by increasing the mode field of light.

FIG. 4B is a diagram illustrating one example of a schematic cross-sectional portion taken along line B-B illustrated in FIG. 3. The schematic cross-sectional portion illustrated in FIG. 4B taken along line B-B illustrated in FIG. 3 is a cross-sectional part of the optical device 1A in which a first adiabatic conversion section 6A is arranged. The optical device 1A includes the Si substrate 12, the clad 11 that is laminated on the Si substrate 12, the first assembly layer 21A, the second assembly layer 21B, the third assembly layer 21C, and the fourth assembly layer 21D. In the first assembly layer 21A, the second tapered waveguide 2B that is included in the first waveguide 2 is arranged. In the second assembly layer 21B, the third tapered waveguide 3A that is included in the second waveguide 3 is arranged. In the third assembly layer 21C, the third waveguide 5 is arranged. In the fourth assembly layer 21D, the fifth waveguide 9 is arranged. In the first adiabatic conversion section 6A, light is adiabatically transitioned between the third tapered waveguide 3A and the second tapered waveguide 2B by way of the third waveguide 5 and the fifth waveguide 9 that are arranged at a position in which the second tapered waveguide 2B and the third tapered waveguide 3A are overlapped in a separated manner in the surface direction of the Si substrate 12.

FIG. 4C is a diagram illustrating one example of a schematic cross-sectional portion taken along line C-C illustrated in FIG. 3. The schematic cross-sectional portion illustrated in FIG. 4C taken along line C-C illustrated in FIG. 3 is a cross-sectional part of the optical device 1A in which the second adiabatic conversion section 7 is arranged. The optical device 1A includes the Si substrate 12, the clad 11 that is laminated on the Si substrate 12, the first assembly layer 21A, the second assembly layer 21B, the third assembly layer 21C, and the fourth assembly layer 21D. In the second assembly layer 21B, the fourth tapered waveguide 3B that is included in the second waveguide 3 is arranged. The fifth tapered waveguide 4A that is included in the fourth waveguide 4 is arranged between the second assembly layer 21B and Si substrate 12.

FIG. 4D is a diagram illustrating one example of a schematic cross-sectional portion taken along line D-D illustrated in FIG. 3. The schematic cross-sectional portion illustrated in FIG. 4D taken along line D-D illustrated in FIG. 3 is a cross-sectional part of the optical device 1A in which the straight line waveguide 4B that is included in the fourth waveguide 4 is arranged. The optical device 1A includes the Si substrate 12, the clad 11 that is laminated on the Si substrate 12, the first assembly layer 21A, the second assembly layer 21B, the third assembly layer 21C, and the fourth assembly layer 21D. The straight line waveguide 4B that is included in the fourth waveguide 4 is arranged between the second assembly layer 21B and the Si substrate 12.

The start point of the first adiabatic conversion section 6A is the start point of the second tapered waveguide 2B that is included in the first waveguide 2, the end point of the third tapered waveguide 3A that is included in the second waveguide 3, and is also the start point of the third waveguide 5, and the start point of the fifth waveguide 9. The end point of the first adiabatic conversion section 6A is the end point of the second tapered waveguide 2B that is included in the first waveguide 2, the start point of the third tapered waveguide 3A that is included in the second waveguide 3, the end point of the third waveguide 5, and is also the end point of the fifth waveguide 9.

The start point of the second adiabatic conversion section 7 is the start point of the fourth tapered waveguide 3B that is included in the second waveguide 3, and is also the end point of the fifth tapered waveguide 4A that is included in the fourth waveguide 4. The end point of the second adiabatic conversion section 7 is the end point of the fourth tapered waveguide 3B that is included in the second waveguide 3, and is also the start point of the fifth tapered waveguide 4A that is included in the fourth waveguide 4.

The optical device 1A according to the second embodiment is constituted to have a structure in which the third waveguide 5 and the fifth waveguide 9 are inserted between the first waveguide 2 and the second waveguide 3, and have a structure in which the waveguide width of each of the third waveguide 5 and the fifth waveguide 9 is set to be narrower than the waveguide width of each of the first waveguide 2 and the second waveguide 3. As a result, it is possible to improve the efficiency of the adiabatic conversion of the first adiabatic conversion section 6A without increasing the size of the first adiabatic conversion section 6. In addition, it is possible to reduce the size of the optical device 1A while reducing the coupling loss with the optical fiber at the chip end surface D11.

In the optical device 1A, the third waveguide 5 and the fifth waveguide 9 are arranged between the first waveguide 2 and the second waveguide 3, so that the third waveguide 5 and the fifth waveguide 9 are constituted to have a two-stage configuration between the first waveguide 2 and the second waveguide 3 by way of the clad 11. As a result, it is possible to improve the efficiency of the adiabatic conversion between the first waveguide 2 and the second waveguide 3.

Furthermore, the optical device 1A may also be constituted such that the third waveguide 5 and the fifth waveguide 9 may be constituted to have a two-stage configuration between the first waveguide 2 and the second waveguide 3, and have a structure in which the space between the first waveguide 2 and the second waveguide 3 is increased. In this case, even if the space between the first waveguide 2 and the second waveguide 3 is increased, it is possible to improve the efficiency of the adiabatic conversion between the first waveguide 2 and the second waveguide 3.

Moreover, in the optical device 1A according to the second embodiment, the case has been described as an example in which the waveguide width of each of the third waveguide 5 and the fifth waveguide 9 that are arranged between the first waveguide 2 and the second waveguide 3 is made constant. However, the example is not limited to this. It may be possible to change the waveguide width of each of the third waveguide 5 and the fifth waveguide 9, and an embodiment thereof will be described below as a third embodiment.

### (c) Third Embodiment

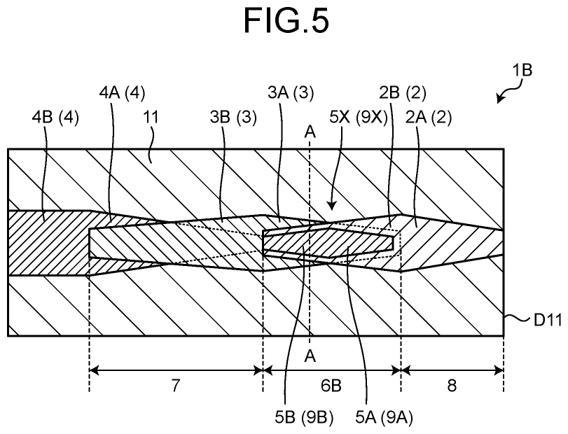

FIG. 5 is a diagram illustrating one example of an optical device 1B according to the third embodiment. In addition, by assigning the same reference numerals to components having the same configuration as those in the optical device 1A according to the second embodiment, overlapped descriptions of the configuration and the operation thereof will be omitted. The optical device 1B is different from the optical device 1A in that a sixth waveguide 5X and a seventh waveguide 9X each having a tapered shape, instead of arranging the third waveguide 5 and the fifth waveguide 9 between the first assembly layer 21A and the second assembly layer 21B.

The sixth waveguide 5X that is a SiN waveguide having a tapered shape is arranged in the third assembly layer 21C that is located between the first assembly layer 21A and the second assembly layer 21B. Furthermore, the seventh waveguide 9X that is a SiN waveguide having a tapered shape is arranged in the fourth assembly layer 21D that is located between the third assembly layer 21C and the first assembly layer 21A.

The sixth waveguide 5X and the seventh waveguide 9X are arranged at a position in which at least the second tapered waveguide 2B and a part of the third tapered waveguide 3A are overlapped in a separated manner in the surface direction of the Si substrate 12, and has a structure in which the waveguide width of each of the sixth waveguide 5X and the seventh waveguide 9X is narrower than that of each of the first waveguide 2 and the second waveguide 3. In addition, the sixth waveguide 5X and the seventh waveguide 9X have substantially the same shape, even though the sixth waveguide 5X and the seventh waveguide 9X are arranged at different portions, i.e. the third assembly layer 21C and the fourth assembly layer 21D, respectively.

The sixth waveguide 5X includes an eleventh tapered waveguide 5A and a twelfth tapered waveguide 5B. The eleventh tapered waveguide 5A has a structure in which the waveguide width is gradually wider as the eleventh tapered waveguide 5A is away from the start point of the second tapered waveguide 2B. The twelfth tapered waveguide 5B has a structure in which the waveguide width is gradually narrower as the twelfth tapered waveguide 5B is away from the start point of the eleventh tapered waveguide 5A when the portion that is connected to the start point of the eleventh tapered waveguide 5A is regarded as the start point of the twelfth tapered waveguide 5B.

The seventh waveguide 9X includes a thirteenth tapered waveguide 9A and a fourteenth tapered waveguide 9B. The thirteenth tapered waveguide 9A has a structure in which the waveguide width is gradually wider as the thirteenth tapered waveguide 9A is away from the start point of the second tapered waveguide 2B. The fourteenth tapered waveguide 9B has a structure in which the waveguide width is gradually narrower as the fourteenth tapered waveguide 9B is away from the start point of the thirteenth tapered waveguide 9A when the portion that is connected to the start point of the thirteenth tapered waveguide 9A is regarded as the start point of the fourteenth tapered waveguide 9B.

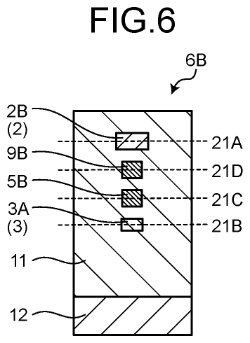

FIG. 6 is a diagram illustrating one example of a schematic cross-sectional portion taken along line B-B illustrated in FIG. 5. The schematic cross-sectional portion illustrated in FIG. 6 taken along line B-B illustrated in FIG. 5 is a cross-sectional part of the optical device 1B in which a first adiabatic conversion section 6B is arranged. The optical device 1B includes the Si substrate 12, the clad 11 that is laminated on the Si substrate 12, the first assembly layer 21A, the second assembly layer 21B, the third assembly layer 21C, and the fourth assembly layer 21D. In the first assembly layer 21A, the second tapered waveguide 2B that is included in the first waveguide 2 is arranged. In the second assembly layer 21B, the third tapered waveguide 3A that is included in the second waveguide 3 is arranged. In the third assembly layer 21C, the twelfth tapered waveguide 5B that is included in the sixth waveguide 5X is arranged. In the fourth assembly layer 21D, the fourteenth tapered waveguide 9B that is included in the seventh waveguide 9X is arranged. In the first adiabatic conversion section 6B, light is adiabatically transitioned between the third tapered waveguide 3A and the second tapered waveguide 2B by way of the sixth waveguide 5X and the seventh waveguide 9X that are arranged at a position in which the second tapered waveguide 2B and the third tapered waveguide 3A are arranged overlapped in a separated manner in the surface direction of the Si substrate 12.

The start point of the first adiabatic conversion section 6B is the start point of the second tapered waveguide 2B that is included in the first waveguide 2, and is also the end point of the third tapered waveguide 3A that is included in the second waveguide 3. Furthermore, the start point of the first adiabatic conversion section 6B is the end point of the eleventh tapered waveguide 5A that is included in the sixth waveguide 5X, and is also the end point of the thirteenth tapered waveguide 9A that is included in the seventh waveguide 9X. The end point of the first adiabatic conversion section 6B is the end point of the second tapered waveguide 2B that is included in the first waveguide 2, the start point of the third tapered waveguide 3A that is included in the second waveguide 3, and is also the end point of the twelfth tapered waveguide 5B that is included in the sixth waveguide 5X. Moreover, the end point of the first adiabatic conversion section 6B is the end point of the fourteenth tapered waveguide 9B that is included in the seventh waveguide 9X. At the start point and the end point of the first adiabatic conversion section 6B, the efficiency of the adiabatic conversion is improved by increasing the waveguide width between the start point and the end point while avoiding a change in a sharp refractive index by reducing the waveguide width.

The optical device 1B according to the third embodiment is constituted to have a structure in which the sixth waveguide 5X and the seventh waveguide 9X each having a tapered shape are inserted between the first waveguide 2 and the second waveguide 3, and have a structure in which the waveguide width of each of the sixth waveguide 5X and the seventh waveguide 9X is narrower than the waveguide width of each of the first waveguide 2 and the second waveguide 3. As a result, it is possible to improve the efficiency of the adiabatic conversion of the first adiabatic conversion section 6B as compared to the first adiabatic conversion section 6A according to the second embodiment. In addition, it is possible to reduce the size of the optical device 1B while reducing the coupling loss with the optical fiber at the chip end surface D11.

In the optical device 1B, the sixth waveguide 5X and the seventh waveguide 9X are arranged between the first waveguide 2 and the second waveguide 3, so that the sixth waveguide 5X and the seventh waveguide 9X are constituted to have a two-stage configuration between the first waveguide 2 and the second waveguide 3 by way of the clad 11. It is possible to reduce the optical loss by suppressing an amount of light radiated from the first waveguide 2 to the Si substrate 12.

Furthermore, the optical device 1B may be constituted such that the sixth waveguide 5X and the seventh waveguide 9X are constituted to have a two-stage configuration between the first waveguide 2 and the second waveguide 3, and have a structure in which the space between the first waveguide 2 and the second waveguide 3 is increased. In this case, the space between the first waveguide 2 and the Si substrate 12 is increased, so that it is possible to reduce the optical loss by suppressing an amount of light radiated from the first waveguide 2 to the Si substrate 12.

Moreover, in the optical device 1B according to the third embodiment, the optical coupling between the first waveguide 2 and the optical fiber depends on the thickness of the first waveguide 2. Accordingly, the thickness of the first waveguide 2 may be changed, and an embodiment thereof will be described below as a fourth embodiment.

### (d) Fourth Embodiment

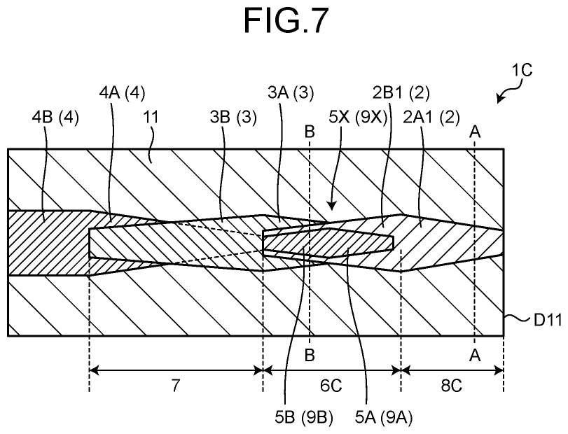

FIG. 7 is a diagram illustrating one example of an optical device 1C according to the fourth embodiment. In addition, by assigning the same reference numerals to components having the same configuration as those in the optical device 1B according to the third embodiment, overlapped descriptions of the configuration and the operation thereof will be omitted. The optical device 1C according to the fourth embodiment is different from the optical device 1B according to the third embodiment in that the thickness of the first waveguide 2 that is optically coupled to the optical fiber is set to be thinner than the thickness of the second waveguide 3.

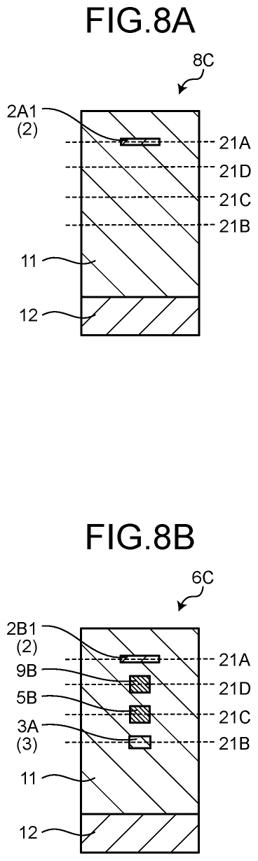

FIG. 8A is a diagram illustrating one example of a schematic cross-sectional portion taken along line A-A illustrated in FIG. 7. The schematic cross-sectional portion illustrated in FIG. 8A taken along line A-A illustrated in FIG. 7 is a cross-sectional part of the optical device 1C in which an inverse tapered section 8C is arranged. The optical device 1C includes the Si substrate 12, the clad 11 that is laminated on the Si substrate 12, the first assembly layer 21A, the second assembly layer 21B, the third assembly layer 21C, and the fourth assembly layer 21D. In the first assembly layer 21A, a first tapered waveguide 2A1 that is included in the first waveguide 2 is arranged. Furthermore, the thickness of the first tapered waveguide 2A1 is set to be thinner than the thickness of the second waveguide 3.

FIG. 8B is a diagram of one example of a schematic cross-sectional portion taken along line B-B illustrated in FIG. 7. The schematic cross-sectional portion illustrated in FIG. 8B taken along line B-B illustrated in FIG. 7 is a cross-sectional part of the optical device 1C in which a first adiabatic conversion section 6C is arranged. The optical device 1C includes the Si substrate 12, the clad 11 that is laminated on the Si substrate 12, the first assembly layer 21A, the second assembly layer 21B, the third assembly layer 21C, and the fourth assembly layer 21D. In the first assembly layer 21A, a second tapered waveguide 2B1 that is included in the first waveguide 2 is arranged. In the second assembly layer 21B, the third tapered waveguide 3A that is included in the second waveguide 3 is arranged. Furthermore, the thickness of the second tapered waveguide 2B1 is set to be narrower than the thickness of the second waveguide 3. In the third assembly layer 21C, the twelfth tapered waveguide 5B that is included in the sixth waveguide 5X is arranged. In the fourth assembly layer 21D, the fourteenth tapered waveguide 9B that is included in the seventh waveguide 9X is arranged. In the first adiabatic conversion section 6C, light is adiabatically transitioned between the third tapered waveguide 3A and the second tapered waveguide 2B by way of the sixth waveguide 5X and the seventh waveguide 9X that are arranged at a position in which the second tapered waveguide 2B and the third tapered waveguide 3A are overlapped in a separated manner in the surface direction of the Si substrate 12.

The start point of the first adiabatic conversion section 6C is the start point of the second tapered waveguide 2B that is included in the first waveguide 2, and is also the end point of the third tapered waveguide 3A that is included in the second waveguide 3. Furthermore, the start point of the first adiabatic conversion section 6C is the end point of the eleventh tapered waveguide 5A that is included in the sixth waveguide 5X, and is also the end point of the thirteenth tapered waveguide 9A that is included in the seventh waveguide 9X. The end point of the first adiabatic conversion section 6C is the end point of the second tapered waveguide 2B that is included in the first waveguide 2, and is also the start point of the third tapered waveguide 3A that is included in the second waveguide 3. Moreover, the end point of the first adiabatic conversion section 6C is the end point of the twelfth tapered waveguide 5B that is included in the sixth waveguide 5X, and is also the end point of the fourteenth tapered waveguide 9B that is included in the seventh waveguide 9X.

In the optical device 1C according to the fourth embodiment, the thickness of the first waveguide 2 is set to be thinner than the thickness of the second waveguide 3, so that it is possible to reduce the coupling loss with the optical fiber by bringing the mode field of light at the chip end surface DI closer to the mode field of the optical fiber.

The optical device 1C is constituted to have a structure in which the sixth waveguide 5X and the seventh waveguide 9X each having a tapered shape is inserted between the first waveguide 2 and the second waveguide 3, and have a structure in which the waveguide width of each of the sixth waveguide 5X and the seventh waveguide 9X are set to be narrower than the waveguide width of each of the first waveguide 2 and the second waveguide 3. As a result, it is possible to improve the efficiency of the adiabatic conversion of the first adiabatic conversion section 6C. In addition, it is possible to reduce the size of the optical device 1C while reducing the coupling loss with the optical fiber at the chip end surface D11.

Furthermore, in the optical device 1C, if the thickness of the second waveguide 3 is increased, the mode field of light in the first adiabatic conversion section 6C is reduced, and thus, an amount of light radiated from the second waveguide 3 to the Si substrate 12 is suppressed. As a result, it is possible to reduce a propagation loss in the first adiabatic conversion section 6C.

However, in the optical device 1C according to the fourth embodiment, the thicknesses of, for example, the first waveguide 2 and the adjacent seventh waveguide 9X are different, so that it is conceivable that the efficiency of the adiabatic conversion is decreased. Accordingly, an embodiment of solving this circumstance will be described below as a fifth embodiment.

### (e) Fifth Embodiment

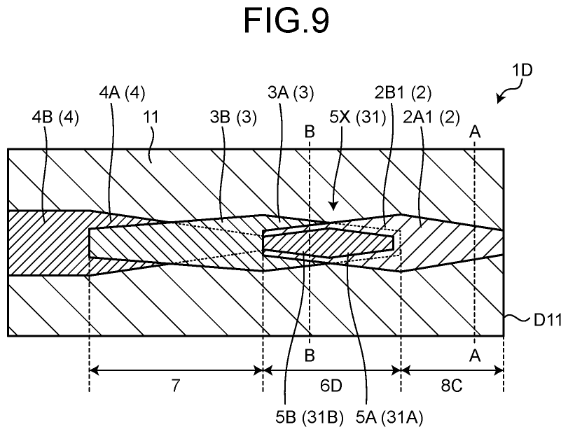

FIG. 9 is a diagram illustrating one example of an optical device 1D according to the fifth embodiment. In addition, by assigning the same reference numerals to components having the same configuration as those in the optical device 1C according to the fourth embodiment, overlapped descriptions of the configuration and the operation thereof will be omitted. The optical device 1D is different from the optical device 1C in that an eighth waveguide 31, in which a difference in thickness between the eighth waveguide 31 and the first waveguide 2 is small, is arranged instead of the seventh waveguide 9X that is adjacent to the first waveguide 2 while reducing the thickness of the first waveguide 2 than the thickness of the second waveguide 3. Furthermore, it is assumed that the difference between the thicknesses of the second waveguide 3 and the adjacent sixth waveguide 5X is made small. Moreover, the thickness of the first waveguide 2 is set to be thinner than the thickness of the second waveguide 3, so that the thickness of the eighth waveguide 31 is thinner than the thickness of the sixth waveguide 5X.

The eighth waveguide 31 includes a fifteenth tapered waveguide 31A and a sixteenth tapered waveguide 31B. The fifteenth tapered waveguide 31A has a structure in which the waveguide width is gradually wider as the fifteenth tapered waveguide 31A is away from the start point of the second tapered waveguide 2B. The sixteenth tapered waveguide 31B has a structure in which the waveguide width is gradually narrower as the sixteenth tapered waveguide 31B is away from the start point of the fifteenth tapered waveguide 31A when the portion that is connected to the start point of the fifteenth tapered waveguide 31A is regarded as the start point of the sixteenth tapered waveguide 31B.

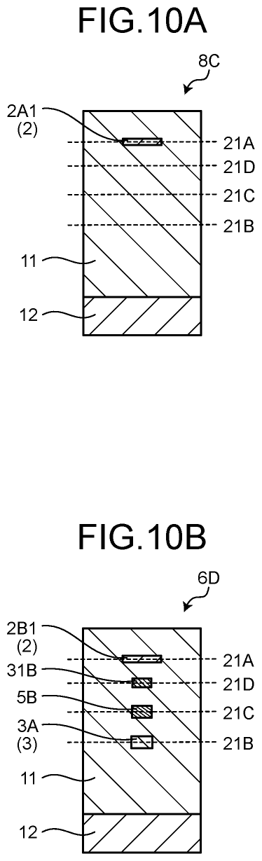

FIG. 10A is a diagram illustrating one example of a schematic cross-sectional portion taken along line A-A illustrated in FIG. 9. The schematic cross-sectional portion illustrated in FIG. 10A taken along line A-A illustrated in FIG. 9 is a cross-sectional part of the optical device 1D in which the inverse tapered section 8C is arranged. The optical device 1D includes the Si substrate 12, the clad 11 that is laminated on the Si substrate 12, the first assembly layer 21A, the second assembly layer 21B, the third assembly layer 21C, and the fourth assembly layer 21D. In the first assembly layer 21A, the first tapered waveguide 2A1 that is included in the first waveguide 2 is arranged.

FIG. 10B is a diagram illustrating one example of a schematic cross-sectional portion taken along line B-B illustrated in FIG. 9. The schematic cross-sectional portion illustrated in FIG. 10B taken along line B-B illustrated in FIG. 9 is a cross-sectional part of the optical device 1D in which a first adiabatic conversion section 6D is arranged. The optical device 1D includes the Si substrate 12, the clad 11 that is laminated on the Si substrate 12, the first assembly layer 21A, the second assembly layer 21B, the third assembly layer 21C, and the fourth assembly layer 21D. In the first assembly layer 21A, the second tapered waveguide 2B1 that is included in the first waveguide 2 is arranged. In the second assembly layer 21B, the third tapered waveguide 3A that is included in the second waveguide 3 is arranged. Furthermore, the thickness of the first waveguide 2 is set to be thinner than the thickness of the second waveguide 3. In the third assembly layer 21C, the twelfth tapered waveguide 5B that is included in the sixth waveguide 5X is arranged. In the fourth assembly layer 21D, the sixteenth tapered waveguide 31B that is included in the eighth waveguide 31 is arranged. Furthermore, the different between the thicknesses of the first waveguide 2 and the eighth waveguide 31 that is disposed adjacent to the first waveguide 2 is made small. Furthermore, the difference between the thicknesses of the second waveguide 3 and the sixth waveguide 5X that is disposed adjacent to the second waveguide 3 is made small. In other words, the difference between the thicknesses of the first waveguide 2 and the eighth waveguide 31, and the difference between the thicknesses of the second waveguide 3 and the sixth waveguide 5X is made small. Therefore, although the thickness of the first waveguide 2 is set to be thinner than the thickness of the second waveguide 3, it is possible to improve the efficiency of the adiabatic conversion between the first waveguide 2 and the eighth waveguide 31 and the efficiency of the adiabatic conversion between the second waveguide 3 and the sixth waveguide 5X. In the first adiabatic conversion section 6D, light is adiabatically transitioned between the third tapered waveguide 3A and the second tapered waveguide 2B by way of the sixth waveguide 5X and the eighth waveguide 31 that are arranged at the position in which the second tapered waveguide 2B and the third tapered waveguide 3A are overlapped in a separated manner in the surface direction of the Si substrate 12.

The start point of the first adiabatic conversion section 6D is the start point of the second tapered waveguide 2B that is included in the first waveguide 2, and is also the end point of the third tapered waveguide 3A that is included in the second waveguide 3. Furthermore, the start point of the first adiabatic conversion section 6D is the end point of the eleventh tapered waveguide 5A that is included in the sixth waveguide 5X, and is also the end point of the fifteenth tapered waveguide 31A that is included in the eighth waveguide 31. The end point of the first adiabatic conversion section 6D is the end point of the second tapered waveguide 2B that is included in the first waveguide 2, and is also the start point of the third tapered waveguide 3A included in the second waveguide 3. Furthermore, the end point of the first adiabatic conversion section 6D is the end point of the twelfth tapered waveguide 5B that is included in the sixth waveguide 5X, and is also the end point of the sixteenth tapered waveguide 31B that is included in the eighth waveguide 31.

In the optical device 1D according to the fifth embodiment, the difference between the thicknesses of the adjacent first waveguide 2 and the eighth waveguide 31 is made small, the difference between the thicknesses of the adjacent second waveguide 3 and the sixth waveguide 5X is made small. As a result, even if the thicknesses of the first waveguide 2 and the second waveguide 3 are changed, it is possible to improve the efficiency of the adiabatic conversion between the first waveguide 2 and the eighth waveguide 31 and the efficiency of the adiabatic conversion between the second waveguide 3 and the sixth waveguide 5X.

The optical device 1D is constituted to have a structure in which the sixth waveguide 5X and the eighth waveguide 31 each having a tapered shape is inserted between the first waveguide 2 and the second waveguide 3, and have a structure in which the waveguide width of each of the sixth waveguide 5X and the eighth waveguide 31 is set to be narrower than the waveguide width of each of the first waveguide 2 and the second waveguide 3. As a result, in the first adiabatic conversion section 6D, it is possible to improve the efficiency of the adiabatic conversion. In addition, by suppressing an amount of light radiated from the first waveguide 2 to the Si substrate 12, it is possible to reduce the size of the optical device 1D while reducing the coupling loss with the optical fiber at the chip end surface D11.

Furthermore, in the optical device 1D, the case has been described as an example in which, for example, in order to reduce the difference between the thicknesses of the first waveguide 2 and the eighth waveguide 31, the first waveguide 2 and the eighth waveguide 31 are constituted to have substantially the same shape in cross section in which propagation constant is the same, but it is best to allow the first waveguide 2 and the eighth waveguide 31 to have the same cross-sectional shape. However, the example is not limited to this, and appropriate modifications are possible.

In addition, in the optical device 1C according to the fourth embodiment, the thicknesses of the adjacent first waveguide 2 and the seventh waveguide 9X are different, so that the efficiency of the adiabatic conversion may possibly be reduced. Accordingly, an embodiment of solving this circumstance will be described below as a sixth embodiment.

### (f) Sixth Embodiment

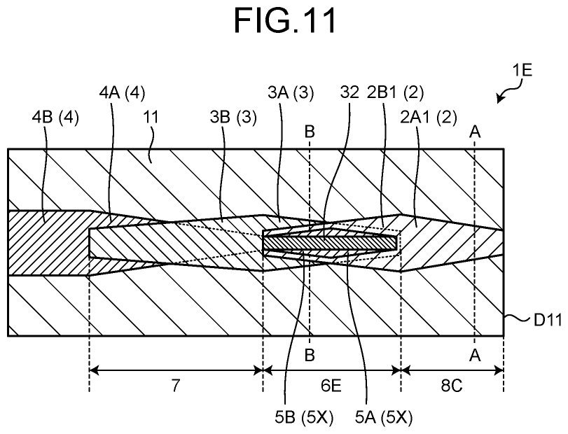

FIG. 11 is a diagram illustrating one example of an optical device 1E according to the sixth embodiment. In addition, by assigning the same reference numerals to components having the same configuration as those in the optical device 1C according to the fourth embodiment, overlapped descriptions of the configuration and the operation thereof will be omitted. The optical device 1E is different from the optical device 1C in that a ninth waveguide 32 having a shape that is different from the shape of each of the sixth waveguide 5X and the sixth waveguide 5X is arrange between the first waveguide 2 and the second waveguide 3 while reducing the thickness of the first waveguide 2 than the thickness of the second waveguide 3.

The sixth waveguide 5X includes the eleventh tapered waveguide 5A and the twelfth tapered waveguide 5B. The eleventh tapered waveguide 5A has a structure in which the waveguide width is gradually wider as the eleventh tapered waveguide 5A is away from the start point of the second tapered waveguide 2B. The twelfth tapered waveguide 5B has a structure in which the waveguide width is gradually narrower as the twelfth tapered waveguide 5B is away from the start point of the eleventh tapered waveguide 5A when the portion that is connected to the start point of the eleventh tapered waveguide 5A is regarded as the start point of the twelfth tapered waveguide 5B.

The ninth waveguide 32 is a straight line waveguide that is a SiN waveguide and that has the same waveguide width from the start point of the second tapered waveguide 2B to the end point of the second tapered waveguide 2B.

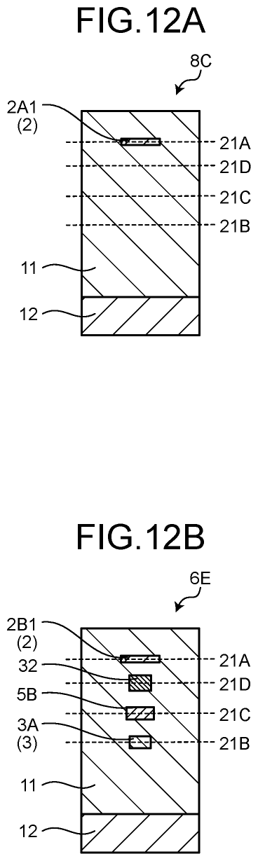

FIG. 12A is a diagram illustrating one example of a schematic cross-sectional portion taken along line A-A illustrated in FIG. 11. The schematic cross-sectional portion illustrated in FIG. 12A taken along line A-A illustrated in FIG. 11 is a cross-sectional part of the optical device 1E in which the inverse tapered section 8C is arranged. The optical device 1E includes the Si substrate 12, the clad 11 that is laminated on the Si substrate 12, the first assembly layer 21A, the second assembly layer 21B, the third assembly layer 21C, and the fourth assembly layer 21D. In the first assembly layer 21A, the first tapered waveguide 2A1 that is included in the first waveguide 2 is arranged.

FIG. 12B is a diagram illustrating one example of a schematic cross-sectional portion taken along line B-B illustrated in FIG. 11. The schematic cross-sectional portion illustrated in FIG. 12B taken along line B-B illustrated in FIG. 11 is a cross-sectional part of the optical device 1E in which a first adiabatic conversion section 6E is arranged. The optical device 1E includes the Si substrate 12, the clad 11 that is laminated on the Si substrate 12, the first assembly layer 21A, the second assembly layer 21B, the third assembly layer 21C, and the fourth assembly layer 21D. In the first assembly layer 21A, the second tapered waveguide 2B1 that is included in the first waveguide 2. In the second assembly layer 21B, the third tapered waveguide 3A that is included in the second waveguide 3 is arranged. Furthermore, the thickness of the first waveguide 2 is set to ve thinner than the thickness of the second waveguide 3. In the third assembly layer 21C, the twelfth tapered waveguide 5B that is included in the sixth waveguide 5X is arranged. In the fourth assembly layer 21D, the ninth waveguide 32 is arranged. Moreover, the waveguide width of the sixth waveguide 5X is set to be wider than the waveguide width of the ninth waveguide 32.

In other words, even if the thicknesses of the first waveguide 2 and the ninth waveguide 32 are different, it is possible to improve the efficiency of the adiabatic conversion between the first waveguide 2 and the ninth waveguide 32 by adjusting the waveguide width of the ninth waveguide 32. Similarly, even if the thicknesses of the second waveguide 3 and the sixth waveguide 5X are different, it is possible to improve the efficiency of the adiabatic conversion between the second waveguide 3 and the sixth waveguide 5X by adjusting the waveguide width of the sixth waveguide 5X. In the first adiabatic conversion section 6E, light is adiabatically transitioned between the third tapered waveguide 3A and the second tapered waveguide 2B1 by way of the sixth waveguide 5X and the ninth waveguide 32 that are arranged at the position in which the second tapered waveguide 2B1 and the third tapered waveguide 3A are overlapped in a separated manner in the surface direction of the Si substrate 12.

The start point of the first adiabatic conversion section 6E is the end point of the second tapered waveguide 2B1 that is included in the first waveguide 2, and is also the start point of the third tapered waveguide 3A that is included in the second waveguide 3. Furthermore, the start point of the first adiabatic conversion section 6E is the end point of the eleventh tapered waveguide 5A that is included in the sixth waveguide 5X, and is also the end point of the ninth waveguide 32. The end point of the first adiabatic conversion section 6E is the start point of the second tapered waveguide 2B1 that is included in the first waveguide 2, and is also the end point of the third tapered waveguide 3A that is included in the second waveguide 3. Moreover, the end point of the first adiabatic conversion section 6E is the end point of the twelfth tapered waveguide 5B that is included in the sixth waveguide 5X, and is also the start point of the ninth waveguide 32.

In the optical device 1E according to the sixth embodiment, even if the thicknesses of the first waveguide 2 and the ninth waveguide 32 are different, it is possible to improve the efficiency of the adiabatic conversion between the first waveguide 2 and the ninth waveguide 32 by adjusting the waveguide width of the ninth waveguide 32. Similarly, even if the thicknesses of the second waveguide 3 and the sixth waveguide 5X are different, it is possible to improve the efficiency of the adiabatic conversion between the second waveguide 3 and the sixth waveguide 5X by adjusting the waveguide width of the sixth waveguide 5X.

The optical device 1E is constituted to have a structure in which the sixth waveguide 5X and the ninth waveguide 32 each having a tapered shape are inserted between the first waveguide 2 and the second waveguide 3, and have a structure in which the waveguide width of each of the sixth waveguide 5X and the ninth waveguide 32 are made narrower than the waveguide width of each of the first waveguide 2 and the second waveguide 3. As a result, in the first adiabatic conversion section 6E, it is possible to improve the efficiency of the adiabatic conversion. In addition, it is possible to reduce the size of the optical device 1E while reducing the coupling loss with the optical fiber at the chip end surface D11.

Furthermore, in the optical device 1E according to the sixth embodiment, in the case where the thickness of the first waveguide 2 is set to be narrower, the mode field of light at the chip end surface D11 is increased. However, in the case where the thickness of SiO₂ of the clad 11 that covers the top surface of the first waveguide 2 is thin, air corresponds to a clad, which results in an occurrence of a situation in which the mode field of light increases. Accordingly, an embodiment of solving this circumstance will be described below as a seventh embodiment.

### (g) Seventh Embodiment

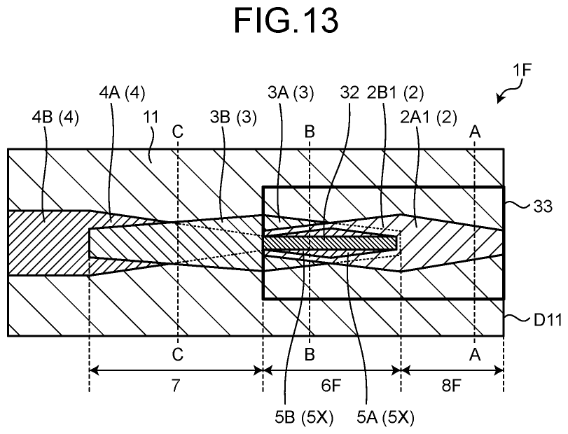

FIG. 13 is a diagram illustrating one example of an optical device 1F according to the seventh embodiment. In addition, by assigning the same reference numerals to components having the same configuration as those in the optical device 1E according to the sixth embodiment, overlapped descriptions of the configuration and the operation thereof will be omitted. The optical device 1F according to the seventh embodiment is different from the optical device 1E according to the sixth embodiment in that an adhesive agent 33 that is a resin layer and that is used in an optical application is applied on the clad 11 that covers the first waveguide 2 that corresponds to the first adiabatic conversion section 6F and the inverse tapered section 8F. For convenience of description, the adhesive agent 33 that is used for an optical application has been indicated as an example, but the example is not limited to this, and optical resin layer may also be used, and appropriate modifications are possible.

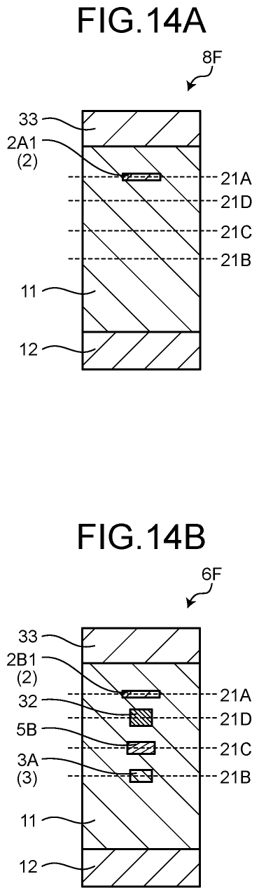

FIG. 14A is a diagram illustrating one example of a schematic cross-sectional portion taken along line A-A illustrated in FIG. 13. The schematic cross-sectional portion illustrated in FIG. 14A taken along line A-A illustrated in FIG. 13 is a cross-sectional part of the optical device 1F in which the inverse tapered section 8F is arranged. The optical device 1F includes the Si substrate 12, the clad 11 that is laminated on the Si substrate 12, the first assembly layer 21A, the second assembly layer 21B, the third assembly layer 21C, the fourth assembly layer 21D, and the adhesive agent 33. In the first assembly layer 21A, the first tapered waveguide 2A1 that is included in the first waveguide 2 is arranged. The adhesive agent 33 is applied on the clad 11 that covers the first waveguide 2 that is included in the inverse tapered section 8F.

FIG. 14B is a diagram illustrating one example of a schematic cross-sectional portion taken along line B-B illustrated in FIG. 13. The schematic cross-sectional portion illustrated in FIG. 14B taken along line B-B illustrated in FIG. 13 is a cross-sectional part of the optical device 1F in which a first adiabatic conversion section 6F is arranged. The optical device 1F includes the Si substrate 12, the clad 11 that is laminated on the Si substrate 12, the first assembly layer 21A, the second assembly layer 21B, the third assembly layer 21C, the fourth assembly layer 21D, and the adhesive agent 33. In the first assembly layer 21A, the second tapered waveguide 2B1 that is included in the first waveguide 2 is arranged.

In the second assembly layer 21B, the third tapered waveguide 3A that is included in the second waveguide 3 is arranged. Furthermore, the thickness of the first waveguide 2 is set to be thinner than the thickness of the second waveguide 3. In the third assembly layer 21C, the twelfth tapered waveguide 5B that is included in the sixth waveguide 5X is arranged. In the fourth assembly layer 21D, the ninth waveguide 32 is arranged. Moreover, the waveguide width of the sixth waveguide 5X is set to be wider than the waveguide width of the ninth waveguide 32. The adhesive agent 33 is applied on the clad 11 that covers the first waveguide 2 that is included in the first adiabatic conversion section 6F. In the first adiabatic conversion section 6F, light is adiabatically transitioned between the third tapered waveguide 3A and the second tapered waveguide 2B1 by way of the sixth waveguide 5X and the ninth waveguide 32 that are arranged at the position in which the second tapered waveguide 2B1 and the third tapered waveguide 3A are overlapped in a separated manner in the surface direction of the Si substrate 12.

The start point of the first adiabatic conversion section 6F is the end point of the second tapered waveguide 2B1 that is included in the first waveguide 2, and is the start point of the third tapered waveguide 3A that is included in the second waveguide 3. Furthermore, the start point of the first adiabatic conversion section 6F is the end point of the eleventh tapered waveguide 5A that is included in the sixth waveguide 5X, and is also the end point of the ninth waveguide 32. The end point of the first adiabatic conversion section 6F is the start point of the first waveguide 2 that is included in the second tapered waveguide 2B1, and is also the end point of the third tapered waveguide 3A that is included in the second waveguide 3. Moreover, the end point of the first adiabatic conversion section 6F is the end point of the twelfth tapered waveguide 5B that is included in the sixth waveguide 5X, and is also the start point of the ninth waveguide.

In the optical device 1F according to the seventh embodiment, the adhesive agent 33 is applied on the clad 11 that covers the first waveguide 2 that is included in the first adiabatic conversion section 6F and the inverse tapered section 8F. As a result, it is possible to increase the mode field of light by using the adhesive agent 33 that has a larger refractive index than air as a clad that is disposed on the first waveguide 2 that is included in the first adiabatic conversion section 6F and the inverse tapered section 8F.

The optical device 1F is constituted to have a structure in which the sixth waveguide 5X and the ninth waveguide 32 each having a tapered shape are inserted between the first waveguide 2 and the second waveguide 3, and have a structure in which the waveguide width of each of the sixth waveguide 5X and the ninth waveguide 32 are made narrower than the waveguide width of each of the first waveguide 2 and the second waveguide 3. As a result, the first adiabatic conversion section 6F is able to improve the efficiency of the adiabatic conversion. In addition, by suppressing an amount of light radiated from the first waveguide 2 to the Si substrate 12, it is possible to reduce the size of the optical device 1F while reducing the coupling loss with the optical fiber at the chip end surface D11.

In addition, in the embodiment, the second tapered waveguide 2B and the third tapered waveguide 3A that are included in the first adiabatic conversion section 6 may be a Planar Lightwave Circuit (PLC) in which both of the core and the clad are made of SiO₂, or may be an InP waveguide or a GaAs waveguide. The core may be made of Si or Si₃N₄, a lower part clad may be made of SiO₂, and an upper part clad may be made of SiO₂ or may be air or the like. In addition, this may be applicable in the case where the material refractive index of the waveguide provided at the transition destination is higher than the material refractive index of the waveguide provided at the transition source. For example, in a case of the PLC, it is also applicable by changing the material refractive index at the transition source and the transition destination by changing an amount of doping into a glass waveguide.

In addition, the SiN waveguide has been exemplified as the first waveguide 2, the second waveguide 3, the third waveguide 5, the fifth waveguide 9, the sixth waveguide 5X, the seventh waveguide 9X, the eighth waveguide 31, and the ninth waveguide 32; the Si waveguide has been exemplified as the fourth waveguide 4; and SiO₂ has been exemplified as the clad 11. However, the refractive index of the material that is used for the clad 11 is smaller than the refractive index of the material that is used for the first waveguide 2. The refractive index of the material that is used for the first waveguide 2, the second waveguide 3, the third waveguide 5, the fifth waveguide 9, the sixth waveguide 5X, the seventh waveguide 9X, the eighth waveguide 31, and the ninth waveguide 32 may be set to be smaller than the refractive index that is used for the material that is used for the fourth waveguide 4. Therefore, appropriate modifications are possible for the materials that are used for the first waveguide 2, the second waveguide 3, the third waveguide 5, the fourth waveguide 4, the fifth waveguide 9, the sixth waveguide 5X, the seventh waveguide 9X, the eighth waveguide 31, and the ninth waveguide 32, and the clad 11.

In the case of the PLC, it is possible to change the material refractive index by changing an amount of doping into the core. In the case of the second waveguide 3 and the fourth waveguide 4, relative refractive index difference is large, so that light is strongly confined, and, as a result, it is possible to implement a bent waveguide having a low loss even if a radius R is small, and it is thus possible to reduce the size of the optical device 1.

The structure of each of the first waveguide 2, the second waveguide 3, the third waveguide 5, the fourth waveguide 4, the fifth waveguide 9, the sixth waveguide 5X, the seventh waveguide 9X, the eighth waveguide 31, and the ninth waveguide 32 may be a rib waveguide, a ridge waveguide, or a channel waveguide, and appropriate modifications are possible. In the case where the structure of each of the first waveguide 2, the second waveguide 3, the third waveguide 5, the fourth waveguide 4, the fifth waveguide 9, the sixth waveguide 5X, the seventh waveguide 9X, the eighth waveguide 31, and the ninth waveguide 32 is a rib waveguide, light is also leaked to a slab portion. Accordingly, the effect of the rough side walls of the core is small, and it is thus possible to suppress an optical loss. In the case where the structure of each of the first waveguide 2, the second waveguide 3, the third waveguide 5, the fourth waveguide 4, the fifth waveguide 9, the sixth waveguide 5X, the seventh waveguide 9X, the eighth waveguide 31, and the ninth waveguide 32 is a channel waveguide, confinement of light is strong. Accordingly, it is possible to sharply bend the waveguide, and it is thus possible to reduce the size of the optical device 1. The clad 11 may be made of an arbitrary material as long as the material refractive index is smaller than that of the core, and appropriate modifications are possible.

The case has been described as an example in which the optical device 1 (1A to 1F) according to the present embodiment is a silicon optical waveguide formed by using Si as the material of the fourth waveguide 4 and by using SiO₂ as the material of the clad 11. However, it is also applicable to a PLC, an InP waveguide, and a GaAs waveguide in which the material of each of the fourth waveguide 4 and the clad 11 is SiO₂.

Furthermore, in the optical devices 1A to 1F according to the present embodiment, the case has been described as an example in which two SiN waveguides are inserted between the first waveguide 2 and the second waveguide 3, but the number of SiN waveguides is not limited to two, and three or more SiN waveguides may be used, and appropriate modifications are possible.

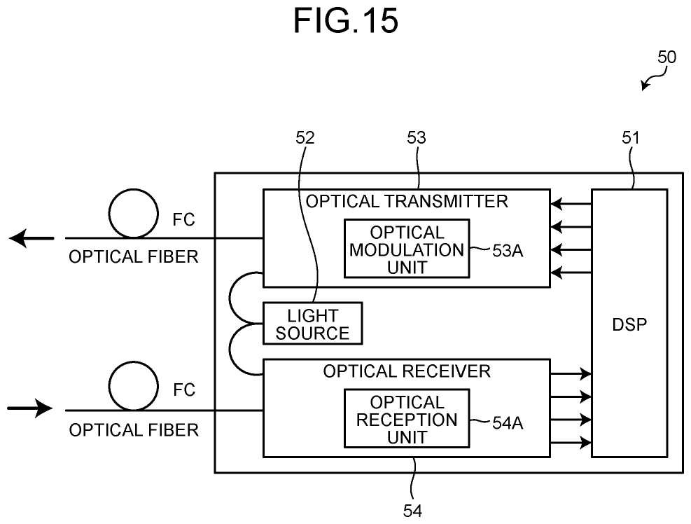

FIG. 15 is a diagram illustrating one example of an optical communication apparatus that includes the optical device 1 as a built-in unit. An optical communication apparatus 50 illustrated in FIG. 15 is connected to an optical fiber disposed on an output side and an optical fiber disposed on an input side. The optical communication apparatus 50 includes a digital signal processor (DSP) 51, a light source 52, an optical transmitter 53, and an optical receiver 54. The DSP 51 is an electrical component that performs digital signal processing. The DSP 51 performs a process of, for example, encoding transmission data or the like, generating an electrical signal including transmission data, and outputs the generated electrical signal to the optical transmitter 53. Furthermore, the DSP 51 acquires an electrical signal including reception data from the optical receiver 54 and obtains reception data by performing a process of, for example, decoding the acquired electrical signal.

The light source 52 includes, for example, a laser diode or the like, generates light with a predetermined wavelength, and supplies the generated light to the optical transmitter 53 and the optical receiver 54. The optical transmitter 53 modulates, by using the electrical signal output from the DSP 51, the light supplied from the light source 52, and outputs the obtained transmission light to the optical fiber. The optical transmitter 53 includes an optical modulation unit 53A that generates the transmission light by modulating, when the light supplied from the light source 52 propagates through the waveguide, the light by using the electrical signal that is input to the optical modulator.

The optical receiver 54 includes an optical reception unit 54A that receives the optical signal from the optical fiber and demodulates the received light by using the light that is supplied from the light source 52. Then, the optical receiver 54 converts the demodulated received light to an electrical signal and outputs the converted electrical signal to the DSP 51. In the optical transmitter 53 and the optical receiver 54, the optical device 1 corresponding to the substrate type optical waveguide element functioning as a waveguide through which light is propagated is installed as a built in device.

The optical device 1 (1A to 1F) included in the optical communication apparatus 50 is constituted to have a structure in which the third waveguide 5 is inserted between the first waveguide 2 and the second waveguide 3, and have a structure in which the waveguide width of the third waveguide 5 is set to be narrower than the waveguide width of each of the first waveguide 2 and the second waveguide 3. In other words, in the optical device 1, the waveguide width of the third waveguide 5 is set to be narrower than the waveguide width of each of the first waveguide 2 and the second waveguide 3. As a result, the mode field of light in the third waveguide 5 and overlap with the mode field of light in the first waveguide 2 and the second waveguide 3 are increased, and thus, optical coupling is likely to occur between the waveguides. Accordingly, it is possible to reduce the length of the waveguide that is needed for adiabatic conversion while improving the coupling efficiency between the second waveguide 3 and the third waveguide 5 and improving the coupling efficiency between the third waveguide 5 and the first waveguide 2. In other words, it is possible to improve the efficiency of the adiabatic conversion of the first adiabatic conversion section 6 without increasing the length of the first adiabatic conversion section 6. In addition, by suppressing an amount of light radiated from the first waveguide 2 to the Si substrate 12, it is possible to reduce the size of the optical communication apparatus 50 while reducing the coupling loss with the optical fiber at the chip end surface D11.

In addition, for convenience of description, the case has been described as an example in which the optical communication apparatus 50 includes the optical transmitter 53 and the optical receiver 54 as the built in units; however the optical communication apparatus 50 may include one of the optical transmitter 53 and the optical receiver 54 as the built in unit. For example, the optical device 1 (1A to 1F) may be applied to the optical communication apparatus 50 having the optical transmitter 53 built in, or the optical communication apparatus 50 having the optical receiver 54 built in, and appropriate modifications are possible.

Each of the components in the units illustrated in the drawings is not always physically configured as illustrated in the drawings. In other words, the specific shape of a separate or integrated unit is not limited to the drawings; however, all or part of the unit can be configured by functionally or physically separating or integrating any of the units depending on various kinds of loads or use conditions.

Furthermore, all or any part of various processing functions performed by each unit may also be executed by a central processing unit (CPU) (or, a microcomputer, such as a micro processing unit (MPU) or a micro controller unit (MCU)). In addition, all or any part of various processing functions may also be, of course, executed by programs analyzed and executed by the CPU (or the microcomputer, such as the MPU or the MCU), or executed by hardware by wired logic.

According to an aspect of an embodiment, it is possible to reduce an optical loss by suppressing an amount of light radiated to a substrate.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
a substrate;
a first assembly layer that is provided on the substrate on a side away from the substrate;
a second assembly layer that is provided on the substrate on a side closer to the substrate; and
a third assembly layer that is provided between the first assembly layer and the second assembly layer, wherein the optical device further includes
a first waveguide that is arranged in the first assembly layer,
a second waveguide that is arranged in the second assembly layer,
a third waveguide that is arranged in the third assembly layer, and
a fourth waveguide that is arranged between the second assembly layer and the substrate, wherein
the third waveguide is arranged at a position in which at least the first waveguide and a part of the second waveguide are overlapped in a surface direction of the substrate, and has a structure in which a waveguide width of the third waveguide is set to be narrower than a waveguide width of each of the first waveguide and the second waveguide.

2. The optical device according to claim 1, wherein
the first waveguide includes
a first tapered waveguide in which a waveguide width is gradually narrower from a start point toward an end point of the first tapered waveguide, and
a second tapered waveguide in which a waveguide width is gradually narrower as the second tapered waveguide is away from the start point of the first tapered waveguide when a portion that is connected to the start point of the first tapered waveguide is regarded as a start point of the second tapered waveguide,
the second waveguide includes
a third tapered waveguide that is arranged at a position in which at least a part of the third tapered waveguide is overlapped with the second tapered waveguide in the surface direction of the substrate, and in which a waveguide width is gradually wider as the third tapered waveguide is away from the start point of the second tapered waveguide, and
a fourth tapered waveguide in which a waveguide width is gradually narrower as the fourth tapered waveguide is away from a portion that is connected to the third tapered waveguide when a portion that is connected to a wider side of the waveguide width of the third tapered waveguide is regarded as a start point of the fourth tapered waveguide, and
the fourth waveguide includes
a fifth tapered waveguide that is arranged at a position in which at least a part of the fifth tapered waveguide is overlapped with the fourth tapered waveguide in the surface direction of the substrate, and in which a waveguide width is gradually wider as the fifth tapered waveguide is away from the start point of the fourth tapered waveguide, and
another waveguide that is connected to a wider side of the waveguide width of the fifth tapered waveguide.

3. The optical device according to claim 1, further including:
a fourth assembly layer that is provided between the first assembly layer and the third assembly layer; and
a fifth waveguide that is provided in the fourth assembly layer, wherein
the fifth waveguide is arranged at a position in which at least a part of the first waveguide and a part of the second waveguide are overlapped in the surface direction of the substrate, and has a structure in which a waveguide width of the fifth waveguide is set to be narrower than the waveguide width of each of the first waveguide and the second waveguide.

4. The optical device according to claim 3, wherein the fifth waveguide is a waveguide that has substantially the same shape as the fourth waveguide.

5. The optical device according to claim 3, wherein the fifth waveguide is a waveguide that has a different shape from the fourth waveguide.

6. The optical device according to claim 3, wherein
the first waveguide includes
a first tapered waveguide in which a waveguide width is gradually narrower from a start point toward an end point of the first tapered waveguide, and
a second tapered waveguide in which a waveguide width is gradually narrower as the second tapered waveguide is away from the start point of the first tapered waveguide when a portion that is connected to the start point of the first tapered waveguide is regarded as a start point of the second tapered waveguide,
the second waveguide includes
a third tapered waveguide that is arranged at a position in which at least a part of the third tapered waveguide is overlapped with the second tapered waveguide in the surface direction of the substrate, and in which a waveguide width is gradually wider as the third tapered waveguide is away from the start point of the second tapered waveguide, and
a fourth tapered waveguide in which a waveguide width is gradually narrower as the fourth tapered waveguide is away from a portion that is connected to the third tapered waveguide when a portion that is connected to a wider side of the waveguide width of the third tapered waveguide is regarded as a start point of the fourth tapered waveguide, and
the fourth waveguide includes
a fifth tapered waveguide that is arranged at a position in which at least a part of the fifth tapered waveguide is overlapped with the fourth tapered waveguide in the surface direction of the substrate, and in which a waveguide width is gradually wider as the fifth tapered waveguide is away from the start point of the fourth tapered waveguide, and
another waveguide that is connected to a wider side of the waveguide width of the fifth tapered waveguide.

7. The optical device according to claim 6, wherein
the third waveguide includes
a sixth tapered waveguide that is arranged at a position in which at least a part of the sixth tapered waveguide is overlapped with the second tapered waveguide in the surface direction of the substrate, and in which a waveguide width is gradually wider as the sixth tapered waveguide is away from the start point of the second tapered waveguide, and
a seventh tapered waveguide in which a waveguide width is gradually narrower as the seventh tapered waveguide is away from a portion that is connected to the sixth tapered waveguide when a portion that is connected to a wider side of the waveguide width of the sixth tapered waveguide is regarded as the start point of the seventh tapered waveguide.

8. The optical device according to claim 6, wherein
the third waveguide includes
a sixth tapered waveguide that is arranged at a position in which at least a part of the sixth tapered waveguide is overlapped with the second tapered waveguide surface direction in the surface direction of the substrate, and in which a waveguide width is gradually wider as the sixth tapered waveguide is away from the start point of the second tapered waveguide, and
a seventh tapered waveguide in which a waveguide width is gradually narrower as the seventh tapered waveguide is away from a portion that is connected to the sixth tapered waveguide when a portion that is connected to a wider side of the waveguide width of the sixth tapered waveguide is regarded as a start point of the seventh tapered waveguide, and
the fifth waveguide is arranged at a position in which at least a part of the fifth waveguide is overlapped with the second tapered waveguide in the surface direction of the substrate, and is a straight line waveguide that extends from the start point of the second tapered waveguide to the end point of the second tapered waveguide.

9. The optical device according to claim 7, wherein
the first waveguide has a structure in which a thickness of the first waveguide is thinner than a thickness of the second waveguide.

10. The optical device according to claim 9, wherein the optical device has a structure in which
a difference between the thickness of the first waveguide and a thickness of the fifth waveguide, and
a difference between the thickness of the second waveguide and a thickness of the third waveguide are small.

11. The optical device according to claim 8, further including an optical resin layer that is arranged on a clad that covers the first waveguide.

12. The optical device according to claim 1, wherein
each of the first waveguide, the second waveguide, and the third waveguide is a waveguide that includes at least Silicon Nitride (SiN), and
the fourth waveguide is a waveguide that includes at least Silicon (Si).

13. An optical transmitter comprising:
a light source;
an optical modulator that performs optical modulation on light received from the light source by using a transmission signal and that transmits transmission light; and
an optical device that guides the light inside the optical modulator, wherein
the optical device includes
a substrate,
a first assembly layer that is provided on the substrate on a side away from the substrate,
a second assembly layer that is provided on the substrate on a side closer to the substrate, and
a third assembly layer that is provided between the first assembly layer and the second assembly layer, wherein the optical device further includes
a first waveguide that is arranged in the first assembly layer,
a second waveguide that is arranged in the second assembly layer,
a third waveguide that is arranged in the third assembly layer, and
a fourth waveguide that is arranged between the second assembly layer and the substrate, wherein
the third waveguide is arranged at a position in which at least the first waveguide and a part of the second waveguide are overlapped in a surface direction of the substrate, and has a structure in which a waveguide width of the third waveguide is set to be narrower than a waveguide width of each of the first waveguide and the second waveguide.

14. The optical transmitter according to claim 13, wherein
the first waveguide includes
a first tapered waveguide in which a waveguide width is gradually narrower from a start point toward an end point of the first tapered waveguide, and
a second tapered waveguide in which a waveguide width is gradually narrower as the second tapered waveguide is away from the start point of the first tapered waveguide when a portion that is connected to the start point of the first tapered waveguide is regarded as a start point of the second tapered waveguide,
the second waveguide includes
a third tapered waveguide that is arranged at a position in which at least a part of the third tapered waveguide is overlapped with the second tapered waveguide in the surface direction of the substrate, and in which a waveguide width is gradually wider as the third tapered waveguide is away from the start point of the second tapered waveguide, and
a fourth tapered waveguide in which a waveguide width is gradually narrower as the fourth tapered waveguide is away from a portion that is connected to the third tapered waveguide when a portion that is connected to a wider side of the waveguide width of the third tapered waveguide is regarded as a start point of the fourth tapered waveguide, and
the fourth waveguide includes
a fifth tapered waveguide that is arranged at a position in which at least a part of the fifth tapered waveguide is overlapped with the fourth tapered waveguide in the surface direction of the substrate, and in which a waveguide width is gradually wider as the fifth tapered waveguide is away from the start point of the fourth tapered waveguide, and
another waveguide that is connected to a wider side of the waveguide width of the fifth tapered waveguide.

15. An optical receiver comprising:
a light source;
an optical reception circuit that receives a reception signal from reception light by using light received from the light source; and
an optical device that guides the light inside the optical reception circuit, wherein
the optical device includes
a substrate,
a first assembly layer that is provided on the substrate on a side away from the substrate,
a second assembly layer that is provided on the substrate on a side closer to the substrate, and
a third assembly layer that is provided between the first assembly layer and the second assembly layer, wherein the optical device further includes
a first waveguide that is arranged in the first assembly layer,
a second waveguide that is arranged in the second assembly layer,
a third waveguide that is arranged in the third assembly layer, and
a fourth waveguide that is arranged between the second assembly layer and the substrate, wherein
the third waveguide is arranged at a position in which at least the first waveguide and a part of the second waveguide are overlapped in a surface direction of the substrate, and has a structure in which a waveguide width of the third waveguide is set to be narrower than a waveguide width of each of the first waveguide and the second waveguide.

16. The optical receiver according to claim 15, wherein
the first waveguide includes
a first tapered waveguide in which a waveguide width is gradually narrower from a start point toward an end point of the first tapered waveguide, and
a second tapered waveguide in which a waveguide width is gradually narrower as the second tapered waveguide is away from the start point of the first tapered waveguide when a portion that is connected to the start point of the first tapered waveguide is regarded as a start point of the second tapered waveguide,
the second waveguide includes
a third tapered waveguide that is arranged at a position in which at least a part of the third tapered waveguide is overlapped with the second tapered waveguide in the surface direction of the substrate, and in which a waveguide width is gradually wider as the third tapered waveguide is away from the start point of the second tapered waveguide, and
a fourth tapered waveguide in which a waveguide width is gradually narrower as the fourth tapered waveguide is away from a portion that is connected to the third tapered waveguide when a portion that is connected to a wider side of the waveguide width of the third tapered waveguide is regarded as a start point of the fourth tapered waveguide, and
the fourth waveguide includes
a fifth tapered waveguide that is arranged at a position in which at least a part of the fifth tapered waveguide is overlapped with the fourth tapered waveguide in the surface direction of the substrate, and in which a waveguide width is gradually wider as the fifth tapered waveguide is away from the start point of the fourth tapered waveguide, and
another waveguide that is connected to a wider side of the waveguide width of the fifth tapered waveguide.
